(19) United States
(12) Patent Application Publication
(10) Pub. No.: US 2005/0261158 A1
(43) Pub. Date: Nov. 24, 2005

(54) Detergent with rinse surfactant and a special alpha-amylase

(75) Inventors: Beatrix Kottwitz, Erkrath (DE); Ulrich Pegelow, Duesseldorf (DE)

Correspondence Address: WOODCOCK WASHBURN LLP, ONE LIBERTY PLACE, 46TH FLOOR, PHILADELPHIA, PA, 19103, US

(73) Assignee: Henkel Kommanditgesellschaft auf Aktien, Duesseldorf (DE)

(21) Appl. No.: 11/113,775

(22) Filed: Apr. 25, 2005

(30) Foreign Application Priority Data
Oct. 4, 2004 (DE) 10 2004 048 591.7
Apr. 27, 2004 (DE) 10 2004 020 430.6

(51) Int. Cl. C11D 17/00

(52) U.S. Cl. 510/421; 510/506

(57) ABSTRACT

The present invention relates to detergents comprising (a) one or more non-ionic surfactants of the general Formula I: 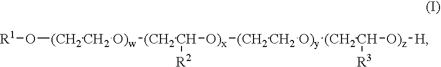 in which R1 stands for a C6-24-alkyl or -alkenyl radical, each group R2 or R3 for defined hydrocarbon radicals and the indices w, x, y, z each stand for whole numbers from 1 to 6, or a surfactant system from at least one non-ionic surfactant F of the general Formula II:
R¹—CH(OH)CH₂O-(AO)_{w}-(A′O)_{l -(A″O)}_{y}-(A′″O)_{z}—R² (II) and at least one non-ionic surfactant G of the general Formula III:
R¹—O—(AO)_{w}-(A′O)ₓ-(A″O)_{y}-(A″O)_{z}—R² (III),

In which R¹ stands for a C₆₋₂₄-alkyl- or -alkenyl radical, R² for a hydrocarbon radical with 2 to 26 carbon atoms, A, A′, A″ und A′″ each for defined hydrocarbon radicals and w, x, y and z each stand for values up to 25, wherein this surfactant system comprises the surfactants F and G in a weight ratio between 1:4 and 100:1, and (b) an α-amylase according to SEQ ID NO. 1 or SEQ ID NO. 2, together with corresponding cleaning processes and application possibilities.

The present invention relates to detergents comprising a special non-ionic surfactant that acts as a rinse surfactant and an x-amylase according to SEQ ID NO. 1 or SEQ ID NO. 2 as well as corresponding cleaning processes and application possibilities.

Surfactants, particularly non-ionic surfactants (niotensides) have long been established in the state of the art as active ingredients in detergents, particularly automatic dishwasher agents. They are used because of their cleaning effect, meaning that they solubilize stains, particularly fatty stains, and so these can be discharged with the wash liquid. In principle, cationic, anionic and also amphoteric surfactants are suitable, although particularly effective representatives were even found among the non-ionic surfactants, which enjoy a corresponding popularity for the manufacture of effective agents. This is especially true for automatic dishwasher agents. Due to the static nature of this cleaning process, special requirements are demanded from these agents concerning the effective performance of the active constituents on the stains.

An additional tendency by the development of cleansers, especially for automatic dishwasher agents, is that as many constituents as possible be presented together, i.e. simultaneously in one, or in directly successively reacting phases. Among these, for example, are the “3 in 1” products that contain washing salts and rinse agents in addition to the real detergent.

For automatic dishwashing, there is an additional trend, from ecological grounds, towards ever lower temperatures, ever shorter wash cycles and a reduced dosage of detergents, care having to be taken in some countries with regard to restrictions on the use of specific constituents such as, for example phosphates.

The three patent applications DE 10136000 A1, DE 10136001 A1 and DE 10136002 A1 disclose automatic dishwasher agents with special non-ionic surfactants that are each defined by physical parameters in a different way: in the first case they are those with a specific dynamic surface tension, in the second case those with a specific viscosity, and in the third case those with a specific diffusion coefficient. These properties make them suitable rinse surfactants. The preferred representatives all correspond to the following general Formula I: 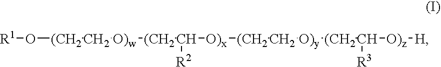
in which R¹ stands for a linear or branched, saturated or mono- or polyunsaturated C₆₋₂₄-alkyl or alkenyl radical, each group R² or R³ independently of one another is selected from —CH₃, —CH₂CH₃, —CH₂CH₂—CH₃ und —CH(CH₃)₂, and the indices w, x, y, z independently of one another stand for whole numbers from 1 to 6. 1603 preferred representatives from the three applications are summarized in one common list.

The unprepublished application DE 102004015392.2 discloses automatic dishwasher agents with above average cleaning and rinsing results and which contain 0.5 to 12 wt. % of a specific surfactant system. This includes
a) at least one non-ionic surfactant F of the general Formula II
   R¹—CH(OH)CH₂O-(AO)_{l -(A′O)}ₓ-(A″O)_{y}-(A″O)_{z}—R² (II),
   in which R¹ stands for a linear or branched, saturated or mono- or polyunsaturated C₆₋₂₄-alkyl or alkenyl radical, each group R² stands for a linear or branched hydrocarbon radical with 2 to 26 carbon atoms, A, A′, A″ und A′″ independently of one another stand for a radical from the group —CH₂CH₂, —CH₂CH₂—CH₂, —CH₂—CH(CH₃), —CH₂—CH₂—CH₂—CH₂, —CH₂—CH(CH₃)—CH₂— und —CH₂—CH(CH₂—CH₃), w, x, y, z for numbers between 0.5 and 25, wherein x, y or z can also be 0 and
b) at least one non-ionic surfactant G of the general Formula III
   R¹—O-(AO)_{w}-(A′O)ₓ-(A″O)_{y}-(A′″O)_{z}—R² (III),
   in which R¹ stands for a linear or branched, saturated or mono- or polyunsaturated C₆₋₂₄-alkyl or alkenyl radical, each group R² stands for a linear or branched hydrocarbon radical with 2 to 26 carbon atoms, A, A′, A″ und A′″ independently of one another stand for a radical from the group —CH₂CH₂, —CH₂CH₂—CH₂, —CH₂—CH(CH₃), —CH₂—CH₂—CH₂—CH₂, —CH₂—CH(CH₃)—CH₂— und —CH₂—CH(CH₂—CH₃), w, x, y, z for numbers between 0.5 and 25, wherein x, y or z can also be 0, the surfactant system comprising the non-ionic surfactants F and G in a weight ratio F:G of 1:4 to 100:1.

These applications indeed disclose that in principle, the non-ionic surfactants cited therein can be combined with additional constituents, including enzymes, in order to hydrolyze relevant stains; however they give no information whatsoever concerning whether and if in the affirmative, which of the enzymes are suitable for the combination, i.e. the simultaneous use with the cited non-ionic surfactants. α-Amylases in general were also cited, however no preferences were disclosed. In addition, the respective examples did not provide any indication relevant to the amylase components. Thus, the expert would be less likely to conclude from this application that the non-ionic surfactants cited therein could be particularly combined with a defined amylase type or any defined variants of wild type enzymes. Thus, it appears that the influence of such non-ionic surfactants on amylases has not yet been the subject of a specific study.

This can probably be explained by the fact that most detergent enzymes, particularly ac-amylases, are added because of their hydrolytic activity as dirt removing agents and consequently in the main cleaning cycle. In typical cleaning applications, they are consequently removed during an intermediate rinsing step, before the rinsing components are made available in a subsequent process step to the material being cleaned.

In particular, the illustrated concept of the “3 in 1” products introduces completely new challenges to the expert. In such compositions, for example in “3 in 1” powders, then according to the solubility of the different phases, many more wash active substances are present together in the cleaning liquid, more or less at the same time. Accordingly, mutual incompatibilities can result or at least the question is raised on which constituents show an optimal action in the presence of the other constituents. In relation to the present application, this question must be asked whether a suitable ax-amylase component would not be rendered unusable by the effects of the non-ionic surfactants, known to be particularly effective and therefore used in automatic dishwasher agents.

Concerning the addition of a-amylase to detergents, a no less rich state of the art exists as that for surfactants.

α-Amylases (E.C. 3.2.1.1) hydrolyze internal α-1,4-glycosidic bonds in starch and starch-like polymers. Because detergents, contrary to rinse agents, exhibit predominantly alkaline pH values, α-amylases that are active in alkaline media are especially used. These are produced and secreted by microorganisms, that is fungi or bacteria, above all those of the species Aspergillus and Bacillus. In the mean time, a virtually unmanageable abundance of variants has been made available from these natural enzymes by means of mutagenesis, which exhibit specific advantages for each area of application.

Examples of these are the x-amylases from Bacillus licheniformis, from B. amyloliquefaciens and from B. stearothermophilus, as well as their improved further developments for use in detergents. The enzyme from B. licheniformis is available from the Novozymes Company under the name Termamyl® and from the Genencor Company under the name Purastar®ST. Further development products of this α-amylase are available from the Novozymes Company under the trade names Duramyl® and Termamyl®ultra, from the Genencor Company under the name Purastar®OxAm and from Daiwa Seiko Inc., Tokyo, Japan as Keistase®. The x-amylase from B. amyloliquefaciens is commercialized by the Novozymes Company under the name BAN®, and derived variants from the α-amylase from B. stearothermophilus under the names BSG® and Novamyl® also from the Novozymes Company.

Point mutations to improve the properties of these enzymes are described, for example, in the unprepublished application DE 10309803.8. In addition, fusion products of these cited molecules for use in detergents are described, for example, in the application WO 03/014358 A2.

Examples of α-amylases from other organisms are the further developments of α-amylase from Aspergillus niger und A. oryzae available from the Novozymes Company under the trade name Fungamyl®. A further commercial product is the Amylase-LT® for example.

Further, attention should be drawn to the ac-amylase from Bacillus sp. A 7-7 (DSM 12368) disclosed in the application WO 02/10356 A2 and the cyclodextrin-glucanotransferase (CGTase) from B. agaradherens (DSM 9948) described in the application WO 02/44350 A2. In addition, in the applications WO 03/002711 A2 and WO 03/054177 A2, for example, sequence spaces of α-amylases are defined which in principal could be suitable for all relevant end uses.

The three patent applications WO 96/23873 A1, WO 00/60060 A2 und WO 01/66712 A2, all filed by the Novozymes Company, form an important background art. WO 96/23873 A1 describes numerous different point mutations in a total of more than 30 different positions in four different wild type amylases and claims these for all amylases with at least 80% identity to one of these four; they should exhibit modified enzymatic properties with respect to thermostability, oxidation stability and calcium dependency. Application WO 00/60060 A2 also names a plurality of possible amino acid substitutions in 10 different positions in α-amylases from two different microorganisms and claims these for all amylases with a homology of at least 96% identity to these. Finally, WO 01/66712 A2 identifies 31 different, in part with the previously cited identical amino acid positions, which have been mutated in one of the two α-amylases cited in the application WO 00/60060 A2. All these variants possess modified enzymatic properties and were thereby claimed for use in detergents and several representatives of them even described. However, special surfactants as constituents of detergents were not suggested here.

Therefore the following can be noted: All these documents relevant to α-amylases and the context of the present invention assume, like all the other descriptions encountered in the prior art of this field, that α-amylases are inherently suitable for use in detergents and molecules with improved utilization properties can be obtained by further developments. However, nowhere in the prior art can be found a description of which α-amylase is particularly suited for the combined use with non-ionic surfactants that are suitable for rinse agents. However, the “3 in 1” situation illustrated above, now requires that α-amylases be found for exactly this field of application.

Accordingly, the object of the invention is to formulate detergents, which combine the advantageous effects of the known non-ionic surfactants with highest performing α-amylase activities.

This is also intended for formulating a “3 in 1” product—in fact a dishwasher agent that simultaneously comprises all the required components for the cleaning process, which retain to a large extent these performance aspects attributed to these two components and deliver cleaning results that are at least equivalent to those obtained by using customary agents added in several separate phases.

This object is achieved by detergents that in addition to further constituents comprise the following components:
non-ionic surfactant, selected from the following group:
non-ionic surfactant with the general Formula I: 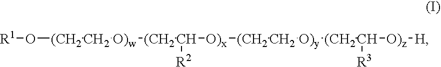
   in which
R¹ stands for a straight chain or branched, saturated or mono- or polyunsaturated C₆₋₂₄ alkyl or alkenyl radical,
each group R² or R³ independently of one another is selected from —CH₃, —CH₂CH₃, —CH₂CH₂—CH₃ and —CH(CH₃)₂ and
the indices w, x, y, z independently of one another stand for whole numbers from 1 to 6,
(ab) mixture of at least two non-ionic surfactants according to (aa) and
(ac) surfactant system from
at least one non-ionic surfactant F of the general Formula II:
   R¹—CH(OH)CH₂O-(AO)_{w}-(A′O)ₓ-(A″O)_{y}-(A′″O)—R² (II),
   in which
R¹ stands for a straight chain or branched, saturated or mono- or polyunsaturated C₆₋₂₄ -alkyl or -alkenyl radical,
R² stands for a linear or branched hydrocarbon radical with 2 to 26 carbon atoms,
A, A′, A″ and A′″ independently of one another stand for a radical from the group —CH₂CH₂, —CH₂CH₂—CH₂, —CH₂—CH(CH₃), —CH₂—CH₂—CH₂—CH₂, —CH₂—CH(CH₃)—CH₂— and —CH₂—CH(CH₂—CH₃), and
w, x, y and z stand for values between 0.5 and 25, wherein x, y and/or z can also be 0, and
at least one non-ionic surfactant G of the general Formula III:
   R¹—O-(AO)_{w}-(A′O)ₓ-(A″O)_{y}-(A′″O)_{z}—R² (III),
   in which
R¹ stands for a straight chain or branched, saturated or mono- or polyunsaturated C₆₋₂₄ -alkyl or -alkenyl radical,
R² stands for H or a linear or branched hydrocarbon radical with 2 to 26 carbon atoms,
A, A′, A″ and A′″ independently of one another stand for a radical from the group —CH₂CH₂, —CH₂CH₂—CH₂, —CH₂—CH(CH₃), —CH₂—CH₂—CH₂—CH₂, —CH₂—CH(CH₃)—CH₂— and —CH₂—CH(CH₂—CH₃), and
w, x, y and z stand for values between 0.5 and 25, wherein y and/or z can also be 0,
wherein this surfactant system comprises the non-ionic surfactants F and G in a weight proportion of F:G between 1:4 and 100:1, and
an α-amylase according to SEQ ID NO. 1 or SEQ ID NO. 2.

The combination of one of these special α-amylases with these special non-ionic surfactants provides a better performance contribution to the overall washing performance of the suitably formulated agent than the combination of these non-ionic surfactants with other α-amylases established in the prior art for use in cleaners.

The term detergent is understood to mean all suitable agents for cleaning hard surfaces according to the prior art. This includes for example cleaners for hard surfaces like metal, glass, porcelain, ceramic, tiles, stone, lacquered surfaces, plastics, wood or leather and above all, as described below, dishwasher agents for dishwashers or manual dishwasher agents. According to the area of use, all possible types of detergents are included, both concentrates and also undiluted agents for use on a commercial scale, in a machine or for cleaning by hand.

Embodiments thereof include all types established by the prior art and/or all required usage forms of the inventive detergents. These include for example solid, powdered, liquid, gel or paste agents, optionally from a plurality of phases, compressed or non-compressed; further included are for example: extrudates, granulates, tablets or pouches, both in bulk and also packed in portions.

In addition to the inventive combination, described below in detail, of non-ionic surfactant and a special α-amylase, a detergent according to the invention optionally comprises further appropriate constituents described in the prior art. These include for example: further surfactants, including above all further non-ionic, but also anionic, cationic and/or amphoteric surfactants, waxes, amphoteric, anionic or cationic polymers, in the case of gels or liquid agents solvents or solution aids, builders, bleaching agents, bleach activators, bleach catalysts, bleach intensifiers, further enzymes, enzyme stabilizers, colorants and/or fragrances, corrosion inhibitors, in the case of tablet shaped agents disintegration additives and/or gas generating effervescing systems, acidifiers and optional customary constituents. Preferred compositions comprise for example buffer substances, stabilizers, reaction partners and/or cofactors of the α-amylase and/or other synergistic constituents with them.

Under the non-ionic surfactant with the general Formula I: 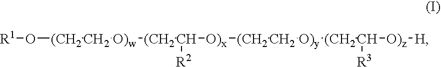
in which R¹ stands for a straight chain or branched, saturated or mono- or polyunsaturated C₆₋₂₄-alkyl or -alkenyl radical, each group R² or R³ independently of one another is selected from —CH₃, —CH₂CH₃, —CH₂CH₂—CH₃ und —CH(CH₃)₂ and the indices w, x, y, z independently of one another stand for whole numbers from 1 to 6, are understood to mean all compounds with the same total formula that are described in the applications DE 10136000 A1, DE 10136001 A1 and DE 10136002 A1, presented in the introduction. In addition, because of the manufacture of this surfactant from the respective monomers, mainly mixtures are formed, particularly in regard to the values for w, x, y and z. Their respective proportions can be controlled by the reaction conditions or by the identity of the added polymerizable reactants. Therefore, the definition of the non-ionic surfactants essential for the invention according to (ab) includes mixtures of at least two non-ionic surfactants that correspond to Formula I.

In general and according to the invention, all the compounds described by the general Formulae I, II and III for component a, are, after consideration of the described variables, identified as rinse surfactants. The addition of these compounds to the detergents and in particular to the rinse components, ensures that the water largely runs off the wares treated with such agents, and that the diverse surfaces are practically free of residues and spotlessly shining at the end of the wash program. Moreover, they will be significantly cleaner by subsequent cleaning processes than those washed with conventional agents. This effect is practically independent of whether the agent is in liquid, powder or tablet form.

These and additional positive effects of the non-ionic surfactants identified under (aa) are due to the physico-chemical properties of the majority of these compounds, which are also described in the cited applications DE 10136000 A1, DE 10136001 A1 and DE 10136002 A1 and relate to the dynamic surface tension, the viscosity and the diffusion coefficients. Accordingly, the representatives hereunder with the following properties characterize preferred embodiments. These properties of the surfactants according to (aa) are described below.

One embodiment is constituted by agents with non-ionic surfactants or surfactant mixtures of Formula I, which exhibit a dynamic surface tension of less than 60 mN in m⁻¹ at a concentration of 0.01 g/l in distilled water at a frequency of 1 Hz.

The lower dynamic surface tension of the surfactant at high concentrations causes a markedly better run-off behavior of the total formulation from the surfaces treated with the detergents. The added inventive surfactants thereby wet the surfaces quickly and above all uniformly, such that the film of rinse solution runs off evenly from the dish and does not prematurely break away. In this manner, spotless and streakless surfaces and thereby improved rinse results are obtained.

In preferred embodiments of the present invention, the surfactant or the surfactant mixture exhibits an even lower dynamic surface tension in a highly concentrated aqueous solution. Inventive agents are preferred, in which the non-ionic surfactant(s) according to Formula I exhibits a dynamic surface tension of less than 55 m Nm⁻¹, preferably less than 50 m Nm⁻¹ at a concentration of 0.01 g/l in distilled water at a frequency of 1 Hz.

Particularly preferred inventive agents comprise one or more non-ionic surfactant(s) according to Formula I, which exhibit a dynamic surface tension of less than 65 m Nm⁻¹, preferably less than 60 m Nm⁻¹ at a concentration of 0.01 g/l in distilled water at a frequency of 5 Hz.

A further embodiment of the present invention is characterized in that such non-ionic surfactants or surfactant mixtures according to Formula I exhibit a viscosity (Brookfield, spindle 31, 30 rpm, 20° C.) of less than 450 mPas at a concentration of 80 wt. % in distilled water.

The lower viscosity of the surfactant at high concentrations causes a markedly improved solubility of the total formulation. Without being bound by any particular theory, one can understand that the dissolution of a pellet or a tablet or a drop of a liquid formulation, each containing high amounts of surfactant, would proceed faster, should the surfactant not pass through a gel phase or should the highly concentrated surfactant solution (formed in the first moments on entry into the water) be so low in viscosity that the further dilution proceeds speedily and without problem.

In addition, the low viscosity of the surfactants used according to the invention in highly concentrated solutions further improves the energy efficiency during production. Thus, for example lower pumping power for conveying the surfactant solutions and lower stirring energy of the mixer for granulating the surfactant solution are required in order to achieve an equivalent dispersion of the surfactant.

A further advantage of the agents according to the invention is their better storage stability in comparison to that of agents with conventional surfactants. Despite the low viscosity of the surfactants, the formulations are not prone to exudation or clumping even in storage under high air humidity and/or temperature.

In preferred embodiments of the present invention, the surfactant or the surfactant mixture according to Formula I exhibits an even lower viscosity in a highly concentrated aqueous solution. Inventive agents are preferred, in which the non-ionic surfactant(s) in an 80 wt. % solution in distilled water exhibit(s) a viscosity (Brookfield, spindle 31, 30 rpm, 20° C.) of less than 400 mPas, preferably less than 300 mPas, particularly preferably less than 250 mPas and especially less than 200 mPas.

Particularly preferred agents according to the invention comprise one or more non-ionic surfactant(s) according to Formula I, which exhibit(s) a viscosity (Brookfield, spindle 31, 30 rpm, 20° C.) of less than 150 mPas at a concentration of 80 wt. % in distilled water. Exemplary values to below 100 mPas can be cited here for the cited conditions (Brookfield, spindle 31, 30 rpm, 20° C., 80 wt. % in distilled water).

It is particularly preferred when more highly concentrated solutions of the added non-ionic surfactants exhibit lower or still lower viscosities. Inventive agents are here preferred, that are characterized in that the non-ionic surfactant(s) according to Formula I in a 90 wt. % solution in distilled water exhibit(s) a viscosity (Brookfield, spindle 31, 30 rpm, 20° C.) of less than 250 mPas, preferably less than 200 mPas, particularly preferably less than 150 mPas and especially less than 100 mPas.

In a further embodiment of the present invention, the non-ionic surfactants or surfactant mixtures according to Formula I are characterized in that at a concentration of 0.01 g/l in distilled water they exhibit a diffusion coefficient of at least 9·10⁻¹¹ m²s⁻¹.

According to the theory of Fainerman et al. (Colloids and Surfaces A, vol. 90 (1994), pages 213 to 224), the diffusion coefficient can be determined from the measurement of the dynamic surface tension.

According to Fainerman's theory, which models the surface film as an ideal gas for short surface ages and small concentrations, the surface pressure P(t)=s₀−s(t) for small surface ages and small surface concentrations can be calculated using

$$Π ( t ) = {σ}_{0} - σ ( t ) = 2 RTc \sqrt{\frac{Dt}{π}}$$

allowing the diffusion coefficient D from the equation

$$D = {π ( \frac{m}{2 RTc} )}^{2}$$

to be calculated, wherein m is the gradient of the straight line in a plot of P vs. t^{1/2}.

In the two previous equations
t: surface age
s(t) surface tension as a function of the surface age
s₀: surface tension of water,
P(t): surface pressure=s₀−s(t),
R: gas constant,
c: molar concentration,
T: temperature and
D: diffusion coefficient.

The greater diffusion coefficient of the surfactant at high concentrations causes a markedly better run-off behavior of the total formulation from the surfaces treated with the detergents. The added inventive surfactants thereby wet the surfaces quickly and above all uniformly, such that the film of rinse solution runs off evenly from the dish and does not prematurely break away. In this manner, spotless and streakless surfaces and thereby improved rinse results are obtained.

In preferred embodiments of the present invention, the surfactant according to Formula I exhibits an even higher diffusion coefficient in a highly concentrated aqueous solution. Inventive agents are preferred, in which the non-ionic surfactant(s) exhibit(s) a diffusion coefficient of at least 9.5·10⁻¹¹ m²s⁻¹, preferably at least 1·10⁻¹⁰ m²s⁻¹ and especially at least 2.5·10⁻¹⁰ m^{2 l s}⁻¹ at a concentration of 0.01 g/l in distilled water.

Particularly preferred agents according to the invention comprise one or more non-ionic surfactant(s) according to Formula I, which exhibit(s) a diffusion coefficient of at least 5·10⁻¹⁰ m²s⁻¹, preferably at least 1·10⁻⁹ m²s⁻¹ and especially at least 5·10⁻⁹ m²s⁻¹ at a concentration of 0.01 g/l in distilled water.

Surfactants essential to the invention according to Formula I can have different molecular structures. Depending on the type and length of the hydrophobic and hydrophilic radicals in the molecule, the properties of the surfactant can be controlled so as to present the desired properties.

The preferred non-ionic surfactants of Formula I can be manufactured by known methods from the corresponding alcohols R¹—OH and ethylene- or alkylene oxide. The radical R¹ in the previous Formula I can vary depending on the origin of the alcohol. Should natural sources be used, the radical R¹ has an even number of carbon atoms and generally is not branched, the linear radicals of alcohols of natural origin with 12 to 18 carbon atoms, for example coconut, palm, tallow or oleyl alcohol being preferred. The alcohols available from synthetic sources are, for example Guerbet alcohols or methyl branched in the 2-position or mixtures of linear and methyl branched radicals, as are typically present in oxo alcohols.

In a preferred embodiment, the non-ionic surfactant (aa) or the surfactant mixture (ab) essential to the invention are manufactured as in the example of DE 10136000.2. Here a mixture of both surfactants 575 and 673 from the Table in the associated descriptive text is manufactured. Those are of the general Formula I, in which R¹ stand respectively for the radical CH₃—(CH₂)₁₀—, R² und R³ respectively for the radical —CH₃ and w and x respectively have the values 3, y respectively 2 and z 1 (for 575) or 2 (for 673). The manufacture proceeds in that a non-branched and saturated C₁₁-alcohol is ethoxylated in an autoclave at 150° C. with ethylene oxide in the presence of KOH as the catalyst. After the ethylene oxide has all reacted, propylene oxide is fed into the autoclave and after its reaction, the procedure with ethylene oxide and finally with propylene oxide is repeated. The resulting surfactant mixture may be described by the Formula
CH₃(CH₂)₁₀—O—(CH₂—CH₂—O)₃—(CH₂—CH(CH₃)—O)₃—(CH₂—CH₂—O)₂—(CH₂—CH(CH₃)—O)_{1,5}—H

This surfactant mixture has a dynamic surface tension of 47 mNm⁻¹ at a concentration of 0.01 g/l in distilled water at a frequency of 1 Hz. Moreover, it has a viscosity (Brookfield, spindle 31, 30 rpm, 20° C.) of 100 mPas at a concentration of 80 wt. % in distilled water, and a diffuision coefficient of 9.1·10⁻¹¹ m²s⁻¹ at a concentration of 0.01 g/l in distilled water. The detergent formulations therein described comprising this surfactant or the surfactant mixture showed the known advantageous effect of this preferred surfactant that is also preferred for the present application.

In addition to propylene oxide, especially butylene oxide can be the alkylene oxide unit that alternates with the ethylene oxide unit in the preferred non-ionic surfactants. However, also other alkylene oxides are suitable, in which R² or R³ independently of one another are selected from —CH₂CH₂—CH₃ or CH(CH₃)₂.

In summary, especially preferred inventive non-ionic surfactants for use in the agents according to the invention are those that have a C₉₋₁₅-alkyl radical with 1 to 4 ethylene oxide units, followed by 1 to 4 propylene oxide units, followed by 1 to 4 ethylene oxide units, followed by 1 to 4 propylene oxide units. These surfactants exhibit the required physico-chemical properties in aqueous solution and according to the invention are used with particular preference.

The cited carbon chain lengths and the ethoxylation or alkoxylation degrees constitute statistical median values that can be a whole or a fractional number for a specific product. Due to the manufacturing process, commercial products of the cited formulae do not consist of one sole representative, but rather are a mixture, wherein not only the carbon chain lengths but also the ethoxylation or alkoxylation degrees can be average values and thus be fractional numbers. Preferred agents according to the invention comprise one or more surfactants from the 1603 representatives, or their mixtures, given in the Tables in the cited applications DE 10136000 A1, DE 10136001 A1 and DE 10136002 A1. The inventive non-ionic surfactants are itemized in these Tables according to the radicals R¹, R² und R³ as well as the indices w, x, y and z. They characterize the preferred embodiments of the present application as well.

Non-ionic surfactants of the general Formula II can be manufactured by reacting an epoxide of the general Formula R¹-CH(O)CH₂, with an alcohol of the general Formula HO-(AO)_{w}-(A′O)ₓ-(A″O)_{y}-(A′″O)_{z}—R² in the presence of a catalyst. (The various variables have the above-cited meanings.)

Weakly foaming non-ionic surfactants, which have alternating ethylene oxide and alkylene oxide units have proved to be the preferred non-ionic surfactants G. Among these, the surfactants with EO-AO-EO-AO blocks are again preferred, wherein one to ten EO or AO groups respectively are linked together, before a block of the other groups follows.

Irrespective of the above-cited physico-chemical properties of the non-ionic surfactants present according to the invention in the agents, in particular according to Formula I (aa) or (ab), it may be advantageous for certain formulations if the surfactants are liquid at room temperature. As well as the easier processability for compositions in the form of powders or granules, this has the additional advantage that the surfactants do not have to be melted during processing, as a result of which the production costs can be further reduced.

According to the invention, one of the two α-amylases to be combined with the rinse agent is described in the sequence protocol SEQ ID NO. 1 of the present application. This is a variant of the α-amylase AA349, which can be derived from this enzyme by the point or deletion mutations R118K, F145E, G182-, D183-, N195F, R320K and R458K. The sequence is presented in SEQ ID NO. 3 and originally emanates from the application WO 00/60060 A2 discussed in the introduction. On the amino acid level, it is identical with the α-amylase AA560, which is described in the same application. In accordance with this application, both wild type enzymes are formed naturally from Bacillus species strains, which have been deposited under the numbers DSM 12648 and DSM 12649 at the Deutschen Sammlung von Mikroorganismen und Zellkulturen GmbH, Mascheroder Weg 1b, 38124 Braunschweig (http://www.dsmz.de) by the Novozymes company.

According to the invention, the other of the two α-amylases to be combined with the rinse agent is described in the sequence protocol SEQ ID NO. 2 of the present application. This is also a variant of the α-amylase AA349, which can be derived from this enzyme by the point or deletion mutations R118K, G182-, D183-, N195F, R320K, R458K; that is, in comparison to the α-amylase of SEQ ID NO.1, the wild type is again prepared by a point mutation in position 145 at exactly this position.

An alignment of the amino acid sequences of the α-amylase according to SEQ ID NO.1 and 2 and the α-Amylase AA349 (AA349) is shown in FIG. 1 of the present application. The seven or six positions in which the differences occur between these sequences and that of AA349 are highlighted by gray markings; they lie in different parts of the molecule.

One can recognize by comparing with the three patent applications discussed in the introduction WO 96/23873 A1, WO 00/60060 A2 und WO 01/66712 A2, that those mutations that characterize identified molecules as suitable in the present application, are already identified beside many others in these applications. However, nowhere is it disclosed that explicitly these seven or six point mutations in their combination with each other, that is the deletion of two neighboring amino acids, in combination with three exchanges of arginine to lysine, one of asparagine to phenylalanine and in one case the additional exchange of phenylalanine to glutamic acid, each in defined positions result in such effective molecules. In particular, it cannot be recognized from this that these specific enzymes provide advantageous effects in cleaners for hard surfaces, and quite particularly not in combination with a non-ionic surfactant, which is normally used as a rinsing surfactant.

The α-amylase activity (E.C. 3.2.1.1; see above) is for example, measured according to the applications WO 97/03160 A1 and GB 1296839 in KNU (Kilo Novo Units). Thus, 1 KNU stands for the quantity of enzymes that hydrolyzes 5.25 g starch (obtainable from Merck, Darmstadt, Germany) per hour at 37° C., pH 5.6 and in the presence of 0.0043 M calcium ions. An alternative method for determining activity is the DNS method, which, for example is described in the application WO 02/10356 A2. According to this, the oligosaccharides, disaccharides and glucose units liberated by the enzyme during starch hydrolysis are detected by oxidation of the reducing ends with dinitrosalicylic acid (DNS). The activity is obtained in [mol reducing sugar (based on maltose) per min and ml; activity values result in TAU. The same enzyme can be determined using various methods, in which methods the conversion factors may vary for each enzyme and therefore must be determined by means of a standard. By approximation, one can calculate that 1 KNU is equivalent to ca. 50 TAU. A further method for determining activity is by measuring using the Quick-Start® test kit from Abbott, Abott Park, Ill., USA.

These enzymes used in the inventive agents can be produced like all the other established enzymes used in detergents according to known biotechnological methods using suitable microorganisms either by filamentary fungi as the transgenic expression host or preferably those of the species Bacillus, as the starting enzymes AA349 and AA560 are themselves Bacillus enzymes. To prepare the corresponding expression constructs, the nucleotide sequences described for example in SEQ ID NO. 1 or 3 in WO 00/60060 A2 are used and by point mutagenesis, for example conducted with the Mismatch primer of the highlighted substitutions in FIG. 1 of the present application. The required procedures are found for example in the handbook from Fritsch, Sambrook und Maniatis “Molecular cloning: a laboratory manual”, Cold Spring Harbour Laboratory Press, New York, 1989. There are now commercial kits available for this, for instance the QuickChange® kit of the Stratagene company, La Jolla, USA. The principal resides therein that oligonucleotides with single substitutions (Mismatch-Primer) are synthesized and hybridized with the provided single stranded gene; subsequent DNA polymerization then affords the corresponding point mutants. These genes are integrated by known methods in vectors and these are used to prepare the desired expression hosts.

A rich background art is available for the biotechnological preparation of proteins using expression hosts. Purification follows conveniently using established processes such as precipitation, sedimentation, concentration, filtration of the liquid phases, microfiltration, ultrafiltration, mixing with chemicals, for instance for precipitation, chromatographic steps, deodorization or suitable combinations of these steps.

The obtained enzymes relevant to the invention can be added to the inventive agents in each established form according to the prior art. Particularly included are solid preparations obtained by granulation, extrusion or lyophilization, advantageously highly concentrated, of low humidity and/or mixed with stabilizers. As an alternative application form, the enzymes can also be encapsulated, for example by spray drying or extrusion of the enzyme solution together with a preferably natural polymer or in the form of capsules, for example those in which the enzyme is embedded in a solidified gel, or in those of the core-shell type, in which an enzyme-containing core is covered with a water-, air- and/or chemical-impervious protective layer. Further active principles, for example stabilizers, emulsifiers, pigments, bleaches or colorants can be applied in additional layers. Such capsules are made using known methods, for example by vibratory granulation or roll compaction or by fluid bed processes. Advantageously, these types of granulates, for example with an applied polymeric film former are dust-free and as a result of the coating are storage stable.

In addition, it is possible to formulate further enzymes with an α-amylase that is essential to the invention, such that a single granulate exhibits a plurality of enzymatic activities. Fundamentally, all types of enzymes used in detergents can be added to the inventive agents separately or in a common formulation with the α-amylase according to SEQ ID NO. 1 or 2. These will be described in detail below.

In a preferred embodiment, the inventive detergents are automatic dishwasher agents.

The advantages attributable to the non-ionic surfactant(s) are thus particularly well evidenced in such agents. The characteristic constituents, particularly for automatic dishwasher agents will now be summarized in a non-exhaustive statement; this summary, however, is not limited to automatic dishwasher agents, but fundamentally is valid for all types of detergents as in principal they display the same chemical properties in them.

In addition to the non-ionic surfactants according to the invention as components (a) in the agents, the agents according to the invention can comprise further surfactants from the groups of non-ionic, anionic, cationic or amphoteric surfactants. Preferred additional non-ionic surfactants are alkoxylated, advantageously ethoxylated, particularly primary alcohols, preferably containing 8 to 18 carbon atoms and, on average, 1 to 12 moles of ethylene oxide (EO) per mole of alcohol, in which the alcohol radical may be linear or, preferably, methyl-branched in the 2-position or may contain linear and methyl-branched radicals in the form of the mixtures typically present in oxoalcohol radicals. However, alcohol ethoxylates containing linear groups of alcohols of natural origin with 12 to 18 carbon atoms, for example coconut, palm, tallow or oleyl alcohol, and on average 2 to 8 EO per mole of alcohol are particularly preferred. Preferred ethoxylated alcohols include, for example, C₁₂₋₁₄ alcohols containing 3 EO or 4 EO, C₉₋₁₁ alcohol containing 7 EO, C₁₃₋₁₅ alcohols containing 3 EO, 5 EO, 7 EO or 8 EO, C₁₂₋₁₈ alcohols containing 3 EO, 5 EO or 7 EO and mixtures thereof, such as mixtures of C₁₂₋₁₄ alcohol containing 3 EO and C₁₂₋₁₈ alcohol containing 5 EO. The degrees of ethoxylation mentioned represent statistical mean values, which, for a special product, can be a whole number or a fractional number. Preferred alcohol ethoxylates have a narrow homolog distribution (narrow range ethoxylates, NRE). In addition to these non-ionic surfactants, fatty alcohols containing more than 12 EO may also be used, examples including tallow fatty alcohol containing 14 EO, 25 EO, 30 EO or 40 EO.

Moreover, other suitable non-ionic surfactants are alkyl glycosides with the general formula RO(G)ₓ where R is a primary, linear or methyl-branched, more particularly 2-methyl-branched, aliphatic radical containing 8 to 22 and preferably 12 to 18 carbon atoms and G stands for a glycose unit containing 5 or 6 carbon atoms, preferably glucose. The degree of oligomerization x, which indicates the distribution of monoglycosides and oligoglycosides, is a number between 1 and 10 and preferably 1.2 to 1,4.

Another class of preferred non-ionic surfactants consists of alkoxylated, preferably ethoxylated, or ethoxylated and propoxylated fatty acid alkyl esters preferably containing 1 to 4 carbon atoms in the alkyl chain.

Non-ionic surfactants of the amine oxide type, for example N-coconutalkyl-N,N-dimethylamine oxide and N-tallowalkyl-N,N-dihydroxy-ethylamine oxide, and the fatty acid alkanolamide can also be suitable. The quantity in which these non-ionic surfactants are used is preferably no more than the quantity in which the ethoxylated fatty alcohols are used and, more preferably, no more than half that quantity.

Other suitable surfactants are polyhydroxyfatty acid amides corresponding to the Formula 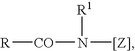
in which RCO is an aliphatic acyl group containing 6 to 22 carbon atoms, R¹ is hydrogen, an alkyl or hydroxyalkyl radical containing 1 to 4 carbon atoms and [Z] is a linear or branched polyhydroxyalkyl radical containing 3 to 10 carbon atoms and 3 to 10 hydroxyl groups. The polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

The group of polyhydroxyfatty acid amides also includes compounds corresponding to the Formula 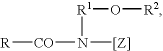
in which R is a linear or branched alkyl or alkenyl radical containing 7 to 12 carbon atoms, R¹ is a linear, branched or cyclic alkyl radical or an aryl radical containing 2 to 8 carbon atoms and R² is a linear, branched or cyclic alkyl radical or an aryl radical or an oxyalkyl radical containing 1 to 8 carbon atoms, C₁₋₄ alkyl or phenyl radicals being preferred, and [Z] is a linear polyhydroxyalkyl radical, of which the alkyl chain is substituted by at least two hydroxyl radicals, or alkoxylated, preferably ethoxylated or propoxylated, derivatives of that radical.

[Z] is preferably obtained by reductive amination of a reduced sugar, for example glucose, fructose, maltose, lactose, galactose, mannose or xylose. The N-alkoxy- or N-aryloxy-substituted compounds may then be converted into the required polyhydroxyfatty acid amides by reaction with fatty acid methyl esters in the presence of an alkoxide as catalyst.

The preferred additional surfactants are weakly foaming non-ionic surfactants. The inventive detergents for automatic dishwashers are especially preferred when they comprise a non-ionic surfactant that exhibits a melting point above room temperature. Accordingly, preferred agents are characterized in that they comprise non-ionic surfactant(s) with a melting point above 20° C., preferably above 25° C., particularly preferably between 25 and 60° C. and especially between 26.6 and 43.3° C.

Suitable additional comprised surfactants are, for example weakly foaming non-ionic surfactants that can be solid or highly viscous at room temperature. If non-ionic surfactants are used that are highly viscous at room temperature, they preferably have a viscosity above 20 Pas, particularly preferably above 35 Pas and especially above 40 Pas. Non-ionic surfactants, which are wax-like in consistency at room temperature, are also preferred.

Non-ionic surfactants solid at room temperature preferably used in accordance with the invention belong to the groups of alkoxylated non-ionic surfactants, more particularly ethoxylated primary alcohols, and mixtures of these surfactants with structurally complex surfactants, such as polyoxypropylene/polyoxyethylene/polyoxypropylene (PO/EO/PO) surfactants. In addition, such (PO/EO/PO) non-ionic surfactants are distinguished by good foam control.

In one preferred embodiment of the present invention, the non-ionic surfactant with a melting point above room temperature is an ethoxylated non-ionic surfactant that results from the reaction of a monohydroxyalkanol or alkylphenol containing 6 to 20 carbon atoms with preferably at least 12 moles, particularly preferably at least 15 moles and especially at least 20 moles of ethylene oxide per mole of alcohol or alkylphenol.

A particularly preferred non-ionic surfactant that is solid at room temperature is obtained from a straight-chain fatty alcohol containing 16 to 20 carbon atoms (C₁₆₋₂₀ alcohol), preferably a C₁₈ alcohol, and at least 12 moles, preferably at least 15 moles and more preferably at least 20 moles of ethylene oxide. Of these non-ionic surfactants, the so-called narrow range ethoxylates (see above) are particularly preferred.

Thus, particularly preferred agents according to the invention comprise ethoxylated non-ionic surfactant(s) prepared from C₆₋₂₀ -monohydroxy alkanols or C₆₋₂₀-alkyl phenols or C₁₆₋₂₀-fatty alcohols and more than 12 mole, preferably more than 15 mole and especially more than 20 mole ethylene oxide per mole alcohol.

The non-ionic surfactant preferably contains additional propylene oxide units in the molecule. These PO units preferably make up as much as 25% by weight, more preferably as much as 20% by weight and especially up to 15% by weight of the total molecular weight of the non-ionic surfactant. Particularly preferred non-ionic surfactants are ethoxylated monohydroxy alcohols or alkyl phenols that have additional polyoxyethylene-polyoxypropylene block copolymer units. The alcohol or alkylphenol component of these non-ionic surfactant molecules preferably makes up more than 30% by weight, more preferably more than 50% by weight and especially more than 70% by weight of the total molecular weight of these non-ionic surfactants. Preferred rinse agents are characterized in that they comprise ethoxylated and prppoxylated non-ionic surfactants, in which the propylene oxide units in the molecule preferably make up as much as 25% by weight, more preferably as much as 20% by weight and, especially up to 15% by weight of the total molecular weight of the non-ionic surfactant.

Other particularly preferred non-ionic surfactants with melting points above room temperature contain 40 to 70% of a polyoxypropylene/polyoxyethylene/polyoxypropylene block polymer blend which contains 75% by weight of an inverted block copolymer of polyoxyethylene and polyoxypropylene with 17 moles of ethylene oxide and 44 moles of propylene oxide and 25% by weight of a block copolymer of polyoxyethylene and polyoxypropylene initiated with trimethylol propane and containing 24 moles of ethylene oxide and 99 moles of propylene oxide per mole of trimethylol propane.

Non-ionic surfactants, which may be used with particular advantage are obtainable, for example, under the name of Poly Tergent® SLF-18 from Olin Chemicals.

Other preferred non-ionic surfactants are the end-capped poly(oxyalkylated) non-ionic surfactants corresponding to the following Formula
R¹O[CH₂CH(R³)O]ₓ[CH₂]ₖCH(OH)[CH₂]ⱼOR²
in which R¹ and R² stand for linear or branched, saturated or unsaturated, aliphatic or aromatic hydrocarbon radicals with 1 to 30 carbon atoms, R³ stands for H or for a methyl, ethyl, n-propyl, isopropyl, n-butyl, 2-butyl or 2-methyl-2-butyl radical, x stands for values between 1 and 30, k and j for values between 1 and 12, preferably 1 to 5. Where x has a value of ≧2, each substituent R³ in the above formula may be different. R¹ and R² are preferably linear or branched, saturated or unsaturated, aliphatic or aromatic hydrocarbon radicals containing 6 to 22 carbon atoms, radicals containing 8 to 18 carbon atoms being particularly preferred. H, —CH₃ or —CH₂CH₃ are particularly preferred for the radical R³. Particularly preferred values for x are in the range from 1 to 20 and more particularly in the range from 6 to 15.

As described above, each R³ in the above Formula can be different when x is ≧2. Through this, the alkylene oxide unit in the straight brackets can be varied. If, for example, x has a value of 3, the substituent R³ may be selected to form ethylene oxide (R³═H) or propylene oxide (R³═CH₃) units which may be joined together in any order, for example (EO)(PO)(EO), (EO)(EO)(PO), (EO)(EO)(EO), (PO)(EO)(PO), (PO)(PO)(EO) and (PO)(PO)(PO). The value 3 for x was selected by way of example and may easily be larger, the range of variation increasing with increasing x-values and including, for example, a large number of (EO) groups combined with a small number of (PO) groups or vice versa.

Particularly preferred end-capped poly(oxyalkylated) alcohols corresponding to the above formula have values for both k and j of 1, so that the above formula can be simplified to
R¹O[CH₂CH(R³)O]ₓCH₂CH(OH)CH₂OR²

In this last formula, R¹, R² und R³ are as defined above and x stands for a number from 1 to 30, preferably 1 to 20 and especially 6 to 18. Surfactants in which the substituents R¹and R² have 9 to 14 carbon atoms, R³ stands for H and x takes a value of 6 to 15 are particularly preferred.

Together with the cited surfactants, anionic, cationic and/or amphoteric surfactants can also be added, these playing only a minor role, due to their foam behavior in automatic dishwasher agents, and are mostly added in quantities below 10 wt. %, mostly even below 5 wt. %, for example from 0.01 to 2.5 wt. % respectively, based on the composition. Thus, the agents according to the invention can also comprise anionic, cationic and/or amphoteric surfactants as the surfactant components.

The anionic surfactants used are, for example, those of the sulfonate and sulfate type. Suitable surfactants of the sulfonate type are, preferably, C₉₋₁₃-alkylbenzenesulfonates, olefinsulfonates, i.e. mixtures of alkene- and hydroxyalkanesulfonates, and disulfonates, as are obtained, for example, from C₁₂₋₁₈-monoolefins having a terminal or internal double bond by sulfonation with gaseous sulfur trioxide and subsequent alkaline or acidic hydrolysis of the sulfonation products. Also suitable are alkanesulfonates, which are obtained from C₁₂₋₁₈-alkanes, for example by sulfochlorination or sulfoxidation with subsequent hydrolysis or neutralization. Equally suitable are also the esters of α-sulfo fatty acids (ester sulfonates), e.g. the α-sulfonated methyl esters of hydrogenated coconut, palm kernel or tallow fatty acids.

Further suitable anionic surfactants are sulfated fatty acid glycerol esters. Fatty acid glycerol esters are understood as meaning the monoesters, diesters and triesters, and mixtures thereof, as are obtained in the preparation by esterification of a monoglycerol with 1 to 3 mol of fatty acid or in the transesterification of triglycerides with 0.3 to 2 mol of glycerol. Preferred sulfated fatty acid glycerol esters here are the sulfonation products of saturated fatty acids having 6 to 22 carbon atoms, for example those of caproic acid, caprylic acid, capric acid, myristic acid, lauric acid, palmitic acid, stearic acid or behenic acid.

Preferred alk(en)yl sulfates are the alkali metal salts, and in particular the sodium salts of the sulfuric monoesters of C_{12-C}₁₈-fatty alcohols, for example those of coconut fatty alcohol, tallow fatty alcohol, lauryl, myristyl, cetyl or stearyl alcohol or of C₁₀-C₂₀-oxo alcohols, and those monoesters of secondary alcohols of these chain lengths. Preference is also given to alk(en)yl sulfates of said chain lengths, which contain a synthetic straight-chain alkyl radical, prepared on a petrochemical basis, and which have a degradation behavior analogous to that of the corresponding compounds based on fatty chemical raw materials. From a washing technology viewpoint, the C₁₂-C₁₆-alkyl sulfates and C₁₂-C₁₅-alkyl sulfates and also C₁₄-C₁₅-alkyl sulfates are preferred. In addition, 2,3-alkyl sulfates, which can be obtained as commercial products from Shell Oil Company under the name DAN®, are suitable anionic surfactants.

Also suitable are the sulfuric monoesters of the straight chain or branched C₇₋₂₁-alcohols ethoxylated with 1 to 6 mol of ethylene oxide, such as 2-methyl-branched C₉₋₁₁-alcohols containing, on average, 3.5 mol of ethylene oxide (EO) or C₁₂₋₁₈-fatty alcohols having 1 to 4 EO. Due to their high foaming behavior, they are used in cleaning compositions only in relatively small amounts, for example in amounts of from 1 to 5% by weight.

Further suitable anionic surfactants are also the salts of the alkylsulfosuccinic acids, which are also referred to as sulfosuccinates or as sulfosuccinic esters and which represent monoesters and/or diesters of sulfosuccinic acid with alcohols, preferably fatty alcohols and in particular ethoxylated fatty alcohols. Preferred sulfosuccinates comprise C₈₋₁₈-fatty alcohol radicals or mixtures of these. Particularly preferred sulfosuccinates comprise a fatty alcohol radical derived from ethoxylated fatty alcohols, which themselves represent non-ionic surfactants (for description see below). Here, particular preference is in turn given to sulfosuccinates whose fatty alcohol radicals are derived from ethoxylated fatty alcohols having a narrowed homolog distribution. It is likewise also possible to use alk(en)ylsuccinic acid with preferably 8 to 18 carbon atoms in the alk(en)yl chain or salts thereof.

It is particularly preferred to add mixtures of different non-ionic surfactants in the dishwasher compositions according to the invention. Here, automatic dishwasher agents in particle form are particularly preferred, with a content of
1.0 to 4.0 wt. % non-ionic surfactants from the group of alkoxylated alcohols,
4.0 to 24.0 wt. % non-ionic surfactants from the group of alkoxylated alcohols that contain hydroxyl groups (hydroxy mixed ethers).

The group a) non-ionic surfactants are described above in detail, wherein the automatic dishwasher agents comprising the previously cited mixtures, particularly C₁₂₋₁₄ fatty alcohols containing 5 EO and 4 PO and C₁₂₋₁₈ fatty alcohols containing on average 9 EO have proved to be outstanding. End-capped non-ionic surfactants, particularly C₁₂₋₁₈ fatty alcohol 9 EO butyl ether, may also be used with similar advantage.

Group b) surfactants show, for example, outstanding rinsing effects and reduce stress cracking in plastics. They also have the advantageous property that their wetting behavior is constant over the entire usual temperature range. In a particularly preferred embodiment, the group b) surfactants are alkoxylated alcohols containing hydroxyl groups. All the hydroxy mixed ethers disclosed therein are, without exception, advantageously comprised as the surfactant from group b) in the preferred inventive dishwasher agents.

The preferred inventive dishwasher agents can comprise the surfactants from groups a) and b) in amounts that vary according to the desired product and preferably lie between narrow limits. Particularly preferred automatic dishwasher agents comprise
1.5 to 3.5 wt. %, preferably 1.75 to 3,0 wt. % and especially 2.0 to 2,5 wt. % non-ionic surfactants from the group of alkoxylated alcohols.
4.5 to 20.0 wt. %, preferably 5.0 to 15.0 wt. % and especially 7.0 to 10.0 wt. % non-ionic surfactants from the group of alkoxylated alcohols that comprise hydroxyl groups (hydroxy mixed ethers).

The non-ionic surfactant(s) can be mixed into the inventive agent by various means. The surfactants can for example be sprayed as a melt onto the otherwise finished agent or is added to the agent in the form of compounds or in the form of surfactant preparations.

Further suitable anionic surfactants are, in particular, soaps. Suitable soaps include saturated fatty acid soaps, such as the salts of lauric acid, myristic acid, palmitic acid, stearic acid, hydrogenated erucic acid and behenic acid, and in particular mixtures of soaps derived from natural fatty acids, e.g. coconut, palm kernel or tallow fatty acids.

The anionic surfactants, including the soaps, may be present in the form of their sodium, potassium or ammonium salts and also as soluble salts of organic bases, such as mono-, di- or triethanolamine. Preferably, the anionic surfactants are in the form of their sodium or potassium salts, in particular in the form of the sodium salts.

As cationic active substances, the products according to the invention may, for example, comprise cationic compounds of the following three formulae: 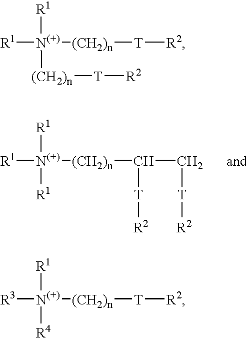
in which each group R¹, independently of one another, is chosen from C₁₋₆-alkyl, -alkenyl or -hydroxyalkyl groups; each group R², independently of one another, is chosen from C₈₋₂₈-alkyl or -alkenyl groups; R³═R¹ or (CH₂)ₙ-T-R²; R⁴═R¹ or R² or (CH₂)ₙ-T-R²; T=-CH₂—, —O—CO— or —CO—O— and n is an integer from 0 to 5.

In summary, preferred agents according to the invention comprise the surfactant(s) in quantities of 0.1 to 60 wt. %, preferably from 0,5 to 50 wt. %, particularly preferably from 1 to 40 wt. % and especially from 2 to 30 wt. %, each based on the rinse agent.

Inventive agents, especially automatic dishwasher agents, preferably comprise copolymers that contain sulfonic acid groups, which together with the monomers from which they are constructed will now be described. In the context of the present invention, unsaturated carboxylic acids of the following Formula are preferred,
R¹(R²)C═C(R³)COOH
in which R¹ to R³ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, wherein R⁴ is a saturated or unsaturated, linear or branched hydrocarbon radical containing 1 to 12 carbon atoms. Among the unsaturated carboxylic acids corresponding to Formula I, acrylic acid (R¹═R²═R³═H), methacrylic acid (R¹═R²═H; R³═CH₃) and/or maleic acid (R¹═COOH; R²═R³═H) are particularly preferred.

The preferred monomers containing sulfonic acid groups correspond to those of the Formula,
R⁵(R⁶)C═C(R⁷)—X—SO₃H
in which R⁵ to R⁷ independently of one another stand for —H, —CH₃, a linear or branched, saturated alkyl radical containing 2 to 12 carbon atoms, a linear or branched, mono- or polyunsaturated alkenyl group containing 2 to 12 carbon atoms, with —NH₂, —OH or —COOH substituted alkyl or alkenyl groups as defined above or —COOH or —COOR⁴, where R⁴ is a saturated or unsaturated, linear or branched hydrocarbon radical containing 1 to 12 carbon atoms, and X is an optionally present spacer group selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Among these monomers are those corresponding to Formulae a, b and/or c,
H₂C═CH—X—SO₃H (a),
H₂C═C(CH₃)—X—SO₃H (b),
HO₃S—X—(R⁶)C═C(k⁷)—X—SO₃H (c),
in which R⁶ und R⁷ independently of one another are selected from —H, —CH₃, —CH₂CH₃, —CH₂CH₂CH₃, —CH(CH₃)₂ and X is an optionally present spacer group selected from —CH₂)ₙ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups are 1-acrylamido-1-propanesulfonic acid (X═—C(O)NH—CH(CH₂CH₃) in formula (a)), 2-acrylamido-2-propanesulfonic acid (X═—C(O)NH—C(CH₃)₂ in formula (a)), 2-acrylamido-2-methyl-1-propanesulfonic acid (X═—C(O)NH—CH(CH₃)CH₂— in formula (a)), 2-methacrylamido-2-methyl-1-propanesulfonic acid (X═—C(O)NH—H(CH₃)CH₂— in formula (b)), 3-methacrylamido-2-hydroxypropanesulfonic acid (X═—C(O)NH—CH₂OH(OH)CH₂— in formula (b)), allyl sulfonic acid (X═CH₂ in formula (a)), methallylsulfonic acid (X═CH₂ in formula (b)), allyloxybenzenesulfonic acid (X═—CH₂—O—C₆H₄— in formula (a)), methallyloxybenzenesulfonic acid (X═—CH₂—O—C₆H₄— in formula (b)), 2-hydroxy-3-(2-propenyloxy)-propanesulfonic acid, 2-methyl-2-propene-1-sulfonic acid (X═CH₂ in formula (b)), styrenesulfonic acid (X═C₆H₄ in formula (a)), vinylsulfonic acid (X not present in formula (a)), 3-sulfopropyl acrylate (X═—C(O)NH—CH₂CH₂CH₂— in formula (a)), 3-sulfopropyl methacrylate (X═—C(O)NH—CH₂CH₂CH₂— in formula (b)), sulfomethacrylamide (X═—C(O)NH— in formula (b)), sulfomethylmethacrylamide (X═—C(O)NH—CH₂— in formula (b)) and water-soluble salts of the acids mentioned.

Additional ionic or non-ionogenic monomers are particularly ethylenically unsaturated compounds. Preferably, the content of other ionic or non-ionogenic monomers in the polymers used according to the invention is less than 20% by weight, based on the polymer. Particularly preferred copolymers for use consist solely of monomers of unsaturated carboxylic acids and monomers that contain sulfonic acid groups. Particularly preferred polymers for use have defined structural units that will be described below.

Thus, for example, inventive automatic dishwasher agents are preferred that are characterized in that they comprise one or more copolymers that comprise structural units of the Formula
—[CH₂—CHCOOH]ₘ—[CH₂—CHC(O)—Y—SO₃H]ₚ—
in which m and p each stand for a whole natural number between 1 and 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred.

These polymers are produced by copolymerization of acrylic acid with an acrylic acid derivative containing sulfonic acid groups. If the acrylic acid derivative containing sulfonic acid groups is copolymerized with methacrylic acid, another polymer is obtained which is also incorporated with preference in the inventive agent and comprises structural units corresponding to the formula
—[CH₂—C(CH₃)COOH]ₘ—[CH₂—CHC(O)—Y—SO₃H]ₚ—
in which m and p are each a whole natural number between 1 to 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred.

Entirely analogously, acrylic acid and/or methacrylic acid may also be copolymerized with methacrylic acid derivatives containing sulfonic acid groups, so that the structural units in the molecule are changed. Copolymers that contain structural units of the Formulae
—[CH₂—CHCOOH]ₘ—[CH₂—C(CH₃)C(O)—Y—SO₃H]ₚ—
in which m and p each stand for a whole natural number between 1 to 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred.
—[CH₂—C(CH₃)COOH]ₘ—[CH₂—C(CH₃)C(O)—Y—SO₃H]ₚ—
in which m and p each stand for a whole natural number between 1 to 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred.

Maleic acid may also be used as a particularly preferred group i) monomer instead of or in addition to acrylic acid and/or methacrylic acid. In this way, it is possible to arrive at preferred agents according to the invention which are characterized in that they comprise one or more copolymers that contain structural units corresponding to the formula
—[HOOCCH—CHCOOH]ₘ—[CH₂—CHC(O)—Y—SO₃H]ₚ—
in which m and p each stand for a whole natural number between 1 to 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred, and to agents characterized in that they comprise one or more copolymers that contain structural units of the Formula
—[HOOCCH—CHCOOH]ₘ—[CH₂—C(CH₃)C(O)O—Y—SO₃H]ₚ—
in which m and p each stand for a whole natural number between 1 to 2000 and Y stands for a spacer group selected from substituted or unsubstituted aliphatic, aromatic or araliphatic hydrocarbon radicals containing 1 to 24 carbon atoms, wherein spacer groups in which Y represents —O—(CH₂)ₙ— with n=0 to 4, —O—(C₆H₄)—, —NH—C(CH₃)₂— or —NH—CH(CH₂CH₃)— are preferred.

The sulfonic acid groups may be present in the polymers completely or partly in neutralized form, i.e. the acidic hydrogen atom of the sulfonic acid groups can be replaced by metal ions, preferably alkali metal ions and more particularly sodium ions, in some or all of the sulfonic acid groups. Corresponding uses, which are characterized in that the sulfonic acid groups in the copolymer are present in partly or fully neutralized form, are preferred according to the invention.

Moreover, combinations of sulfonated copolymers with polymers or copolymers that comprise heteroatoms, in particular those with amino- or phosphono groups are also suitable. The inventive agents are here particularly preferred when they additionally comprise 0.1 to 30 wt. % homo and/or copolymers of polycarboxylic acids or their salts and/or polymers/copolymers that comprise heteroatoms, particularly those comprising amino- or phosphono groups. The combination with polymers/copolymers that comprise heteroatoms is advantageous with builder systems that are only partially based on phosphates, e.g. mixed phosphate/citrate systems.

In accordance with the already cited application DE 10050622.4 A1, 0.1 to 30 wt. % homo and/or copolymers of polycarboxylic acids or their salts can be added to the relevant agent so as to prevent the precipitation of calcium carbonate. A further addition of (d) 5 to 30 wt. % of non-ionic surfactants produces an improvement in the water run-off property and thereby acts additionally against the formation of water marks or streaks, particularly on glass surfaces. The illustrated embodiments in DE 10050622.4 A1 are also correspondingly preferred in the context of the present application.

In applying the teaching of DE 10050622.4 A1, the copolymers that contain sulfonic acid groups can be added in particulate form; accordingly, these embodiments are preferred.

The quantities in which the copolymer(s) that contain sulfonic acid groups is/are added, lie between 0.1 and 70 wt. % based on the total agent. Particularly preferred agents according to the invention are characterized in that they comprise the copolymer(s) containing sulfonic acid groups in quantities from 0.25 to 50 wt. %, preferably from 0,5 to 35 wt. %, particularly preferably from 0.75 to 20 wt. % and especially from 1 to 15 wt. %.

Inventive agents can contain sticky materials, i.e. those materials that melt or soften below the utilization temperature of the agent. Preferred inventive automatic dishwasher agents comprise an additional 2 to 40 wt. %, preferably 3 to 30 wt. % and especially 5 to 20 wt. % of one or more constituents with a melting or softening point below 60° C., non-ionic surfactant(s) being preferred.

Such constituents with melting or softening points below 60° C. can originate from a plurality of substance classes. Many of these constituents do not show a sharply defined melting point, as is normally the case for pure, crystalline substances, but rather a melting region over possibly several degrees Celsius. This lies below 60° C. for the above-cited preferred agents, this limit being only its location, not the width of the melting region. The width of the melting region is advantageously at least 1° C., preferably about 2 to 3° C.

The above-cited properties are generally satisfied by waxes. Waxes are understood to mean a series of natural or synthetic materials that in general melt without decomposition above 40° C. and already a little above their melting point are of relatively low viscosity and not stringy. They exhibit a strongly temperature-dependent consistence and solubility. Waxes are subdivided into three groups depending on their origin, natural waxes, chemically modified waxes and synthetic waxes.

Natural waxes include, for example, plant waxes, such as candelilla wax, carnauba wax, Japan wax, esparto grass wax, cork wax, guaruma wax, rice germ oil wax, sugarcane wax, ouricury wax, or montan wax, animal waxes, such as beeswax, shellac wax, spermaceti, lanolin (wool wax), or uropygial grease, mineral waxes, such as ceresin or ozokerite (earth wax), or petrochemical waxes, such as petrolatum, paraffin waxes or microcrystalline waxes.

Chemically modified waxes include, for example, hard waxes, such as montan ester waxes, sassol waxes or hydrogenated jojoba waxes.

Synthetic waxes are generally understood to mean polyalkylene waxes or polyalkylene glycol waxes. Compounds from other material classes, which fulfil the cited requirements concerning the softening point can also be used for shell materials. Synthetic compounds which have proven suitable are, for example, higher esters of phthalic acid, in particular dicyclohexyl phthalate, which is commercially available under the name Unimoll® 66 (Bayer AG). Also suitable are synthetically prepared waxes from lower carboxylic acids and fatty alcohols, for example dimyristyl tartrate, which is available under the name Cosmacol® ETLP (Condea). Conversely, synthetic or partially synthetic esters of lower alcohols with fatty acids from natural sources may also be used. This class of substance includes, for example, Tegin® 90(Goldschmidt), a glycerol monostearate palmitate.

Also covered by waxes for the purposes of the present invention are, for example, so-called wax alcohols. Wax alcohols are relatively high molecular weight, water-insoluble fatty alcohols having on average about 22 to 40 carbon atoms. The wax alcohols occur, for example, in the form of wax esters of relatively high molecular weight fatty acids (wax acids) as the major constituent of many natural waxes. Examples of wax alcohols are lignoceryl alcohol (1-tetracosanol), cetyl alcohol, myristyl alcohol or melissyl alcohol. The coating of the solid particles coated in accordance with the invention can optionally also comprise wool wax alcohols, which is understood as meaning triterpenoid and steroid alcohols, for example lanolin, which is available, for example, under the trade name Argowax® (Pamentier & Co). As a constituent of the meltable or softenable substances, it is also possible to use, at least partially, for the purposes of the present invention, fatty acid glycerol esters or fatty acid alkanolamides, but also, if desired, water-insoluble or only sparingly water-soluble polyalkylene glycol compounds.

The above-cited waxes can be incrporated into the agents to delay the release of the constituents until a defined time in the cleaning process. So-called fats that can also exhibit melting or softening points below 60° C. are similarly suitable for this.

Fats for the purposes of the present invention are understood to mean materials which are solid at normal temperature (20° C.) from the group of fatty alcohols, fatty acids and fatty acid derivatives particularly fatty acid esters. According to the invention, the preferred fats that can be added are fatty alcohols and fatty alcohol mixtures, fatty acids and fatty acid mixtures, fatty acid esters of alkanols or diols or polyols, amides of fatty acids, fatty amines etc.

Preferred detergent components comprise one or more materials from the groups of fatty alcohols, fatty acids and fatty acid esters.

Fatty alcohols that can be added are for example the alcohols obtained from natural fats and oils, 1-hexanol (caproic alcohol), 1-heptanol (enanthic alcohol), 1-octanol (capryl alcohol), 1-nonanol (pelargonic alcohol), 1-decanol (caprinic alcohol), 1-undecanol, 10-undecen-1-ol, 1-dodecanol (lauryl alcohol), 1-tridecanol, 1-tetradecanol (myristyl alcohol), 1-pentadecanol, 1-hexadecanol (cetyl alcohol), 1-heptadecanol, 1-octadecanol (stearyl alcohol), 9-cis-octadecen-1-ol (oleyl alcohol), 9-trans-octadecen-1-ol (erucyl alcohol), 9-cis-octadecen-1,12-diol (ricinolyl alcohol), all-cis-9,12-octadecadien-1-ol (linoleyl alcohol), all-cis-9,12,15-octadecatrien-1-ol (linolenyl alcohol), 1-nonadecanol, 1-eicosanol (arachidyl alcohol), 9-cis-eicosen-1-ol (gadoleyl alcohol), 5,8,11,14-eicosatetraen-1-ol, 1-heneicosanol, 1-docosanol (behenyl alcohol), 1-3-cis-docosen-1-ol (erucyl alcohol), 1-3-trans-docosen-1-ol (brassidyl alcohol) and their mixtures. According to the invention, Guerbet alcohols and oxo alcohols, e.g. C₁₃₋₁₅-oxo alcohols or mixtures of C₁₂₋₁₈-alcohols with C₁₂₋₁₄-alcohols are also useable as fats. Naturally, alcohol mixtures can also be used, e.g. those such as C₁₆₋₁₈-alcohols manufactured by Ziegler ethylene polymerization. Specific examples of such alcohols are the previously cited alcohols as well as lauryl alcohol, palmityl and stearyl alcohol and mixtures thereof.

Fatty acids are also fats. These are for the most part obtained by hydrolysis of natural fats and oils. While the alkaline saponification process, already used in the previous century led to the alkali salts (soaps), today industrially, only water is used to cleave the fats into glycerin and free fatty acids. Industrially practiced processes are e.g. cleavage in autoclaves or continuous high-pressure cleavage. Carboxylic acids suitable as fats in the context of the present invention are for example hexanoic acid (capronic acid), heptanoic acid (enanthic acid), octanoic acid (caprylic acid), nonanoic acid (pelargonic acid), decanoic acid (caprinic acid), undecanoic acid etc. In the context of the present invention, preferred fatty acids are dodecanoic acid (laurinic acid), tetradecanoic acid (myristinic acid), hexadecanoic acid (palmitinic acid), octadecanoic acid (stearinic acid), eicosanoic acid (arachinic acid), docosanoic acid (behenic acid), tetracosanoic acid (lignocerinic acid), hexacosanoic acid (cerotinic acid), triacotanoic acid (melissinic acid) as well as the unsaturated series 9c-hexadecenoic acid (palmitoleinic acid), 6c-octadecenoic acid (petroselinic acid), 6t-octadecenoic acid (petroselaidinic acid), 9c-octadecenoic acid (olic acid), 9t-octadecenoic acid (elaidinic acid), 9c,12c-octadecadienoic acid (linolic acid), 9t,12t-octadecadienoic acid (linolaidinic acid) und 9c,12c,15c-octadecatrienoic acid (linolenic acid). Naturally, tridecanoic acid, pentadecanoic acid, margarinoic acid, nonadecanoic acid, erucaoic acid, elaeostearic acid and arachidonoic acid are also suitable. For reasons of cost, it is preferred not to use the pure species but rather technical mixtures of the individual acids, just as they are obtained by fat cleavage. Such mixtures are, for example cocoa oil fatty acid (ca. 6 wt. % c₈, 6 wt. % c₁₀, 48 wt. % c₁₂, 18 wt. % c₁₄, 10 wt. % C₁₆, 2 wt. % c₁₈, 8 wt. % C₁₈, 1 wt. % c₁₈″), palm nut oil fatty acid (ca. 4 wt. % c8, 5 wt. % c10, 50 wt. % c12, 15 wt. % c14, 7 wt. % c16, 2 wt. % c18, 15 wt. % c18′, 1 wt. % c18″), tallow fatty acid (ca. 3 wt. % c14, 26 wt. % c16, 2 wt. % c₁₆, 2 wt. % c₁₇, 17 wt. % c18, 44 wt. % c18′, 3 wt. % c18″, 1 wt. % c18′″), hydrogenated tallow fatty acid (ca. 2 wt. % c14, 28 wt. % c16, 2 wt. % c17, 63 wt. % c18, 1 wt. % c18′), technical oleic acid (ca. 1 wt. % c12, 3 wt. % c14, 5 wt. % c16, 6 wt. % c16′, 1 wt. % c17, 2 wt. % c18, 70 wt. % c18′, 10 wt. % c18 ″, 0,5 wt. % c18′″), technical palmitic/stearic acid (ca. 1 wt. % c12, 2 wt. % c14, 45 wt. % c16, 2 wt. % c17, 47 wt. % c18, 1 wt. % c18′) as well as soya bean oil fatty acid (ca. 2 wt. % c14, 15 wt. % c16, 5 wt. % c18, 25 wt. % c18′, 45 wt. % c18″, 7 wt. % c18′″).

Suitable fatty acid esters are esters of fatty acids with alkanols, diols or polyols, fatty acid polyol esters being preferred. Possible fatty acid polyol esters are mono- or diesters of fatty acids with specific polyols. The fatty acids to be esterified with the polyols are preferably saturated or unsaturated fatty acids with 12 to 18 carbon atoms, e.g. lauric acid, myristic acid, palmitic acid or stearic acid, the technically available mixtures of fatty acids being preferred, for example those mixtures of acids from cocoa-, palm nut- or tallow fat. Acids or mixtures of acids with 16 to 18 carbon atoms such as, for example tallow fat acid are especially suitable for esterification with polyhydroxy alcohols. Polyols that come under consideration for esterification with the above-cited fatty acids in the context of the present invention are sorbitol, trimethylolpropane, neopentyl glycol, ethylene glycol, polyethylene glycols, glycerin und polyglycerines.

It is further particularly preferred to add amphoteric or cationic polymers. These particularly preferred polymers are characterized in that they have at least one positive charge. Such polymers are preferably water-soluble or dispersible in water, i.e. their solubility in water at 25° C. is above 10 mg/ml.

Particularly preferred cationic or amphoteric polymers comprise at least one ethylenically unsaturated monomer unit of the general Formula
R¹(R)C═C(R¹)R⁴,
in which R¹ to R⁴ independently of one another stand for —H, —CH₃, a linear or branched, saturated alkyl radical containing 2 to 12 carbon atoms, a linear or branched, mono- or polyunsaturated alkenyl radical containing 2 to 12 carbon atoms, with —NH₂, —OH or —COOH substituted alkyl or alkenyl radicals as defined above, a heteroatomic group with at least one positively charged group, a quaternized nitrogen atom or at least one amine group with a positive charge between pH 2 and 11 or for —COOH or —COOR⁵, wherein R⁵ is a saturated or unsaturated, linear or branched hydrocarbon radical containing 1 to 12 carbon atoms.

Exemplary cited (unpolymerized) monomer units are diallylamine, methyldiallylamine, dimethyldimethylammonium salts, acrylamidopropyl(trimethyl)ammonium salts (R¹, R², und R³, ═H, R⁴═C(O)NH(CH₂)₂N⁺(CH₃)₃X), methacrylamidopropyl(trimethyl)ammonium salts (R¹ und R²═H, R³═CH₃ H, R⁴═C(O)NH(CH₂)₂N⁺(CH₃)₃ X).

Particularly preferred constituents of the amphoteric polymers are unsaturated carboxylic acids of the general Formula
R¹(R²)C═C(R³)COOH
in which R¹ to R³ independently of one another stand for —H, —CH₃, a linear or branched, saturated alkyl radical containing 2 to 12 carbon atoms, a linear or branched, mono- or polyunsaturated alkenyl radical containing 2 to 12 carbon atoms, with —NH₂, —OH or —COOH substituted alkyl or alkenyl radicals as defined above or —COOH or —COOR⁴, wherein R⁴ is a saturated or unsaturated, linear or branched hydrocarbon radical containing 1 to 12 carbon atoms.

Particularly preferred amphoteric polymers comprise monomer units derived from diallylamine, particularly dimethyldiallylammonium salts and/or methacrylamidopropyl(trimethyl)-ammonium salts, preferably in the form of chlorides, bromides, iodides, hydroxides, phosphates, sulfates, hydrogen sulfates, ethylsulfates, methylsulfates, mesylates, tosylates, formates or acetates in combination with monomer units from the group of ethylenically unsaturated carboxylic acids.

The inventive agents can also comprise materials with melting points or softening points, which in general are comprised in the agent to improve the performance of said agent. Such materials are particularly non-ionic surfactants (niotensides), hereunder preferably only slightly foaming non-ionic surfactants.

Non-aqueous solvents that can be added to the inventive agents originate from the group of mono- or polyvalent alcohols, alkanolamines or glycol ethers, in so far that they are miscible with water in the defined concentrations. Preferably, the solvents are selected from ethanol, n- or i-propanol, butanols, glycol, propane- or butanediol, glycerin, diglycol, propyl- or butyldiglycol, hexylene glycol, ethylene glycol methyl ether, ethylene glycol ethyl ether, ethylene glycol propyl ether, etheylene glycol mono-n-butyl ether, diethylene glycol methyl ether, diethylene glycol ethyl ether, propylene glycol methyl-, -ethyl- or -propyl ether, dipropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents, such that rinse agents are characterized in that they comprise the non-aqueous solvent(s), preferably ethanol, n-propanol, i-propanol, 1-butanol, 2-butanol, glycol, propanediol, butanediol, glycerin, diglycol, propyldiglycol, butyldiglycol, hexylene glycol, ethylene glycol methyl ether, ethylene glycol ethyl ether, ethylene glycol propyl ether, etheylene glycol mono -n-butyl ether, diethylene glycol methyl ether, diethylene glycol-ethyl ether, propylene glycol methyl-, -ethyl- or -propyl ether, dipropylene glycol methyl-, or -ethyl ether, methoxy-, ethoxy- or butoxy triglycol, 1-butoxyethoxy-2-propanol, 3-methyl-3-methoxybutanol, propylene glycol t-butyl ether, as well as mixtures of these solvents.

The rinse agents of the present invention can also comprise hydrotropes. The addition of such materials causes a difficultly soluble substance to become water-soluble in the presence of the hydrotrope that is itself not a solvent. Substances that cause such an improved solubility are referred to as hydrotropes or hydrotropica. Typical hydrotropes, for example in the fabrication of liquid detergents, are xylene- and cumene sulfonate. Other substances, for example urea or N-methylacetamide, increase the solubility by means of a structure-breaking effect by which the water structure in the proximity of the hydrophobic group of a difficultly soluble material is broken down.

In the context of the present invention, preferred rinse agents comprise solubilizers, preferably aromatic sulfonates corresponding to the Formula
(R1, R2, R3, R4, R5)-Phenyl-SO³⁻X⁺
in which each of the radicals R₁, R₂, R₃, R₄, R₅ independently of one another is selected from H or a C₁₋₅-alkyl or -alkylene radical and X stands for a cation.

Preferred substituents R₁, R₂, R₃, R₄, R₅ independently of one another are accordingly selected from H or a methyl, ethyl, n-propyl, iso-propyl, n-butyl, iso-butyl, tert-butyl, n-pentyl, iso-pentyl or neo-pentyl radical. Generally, at least three of the cited radicals R¹ to R⁵ are hydrogen atoms, aromatic sulfonates being preferred in which three or four substituents on the aromatic ring are hydrogen atoms. The remaining or remaining two radical(s) can take any position with respect to the sulfonate group and to each other. For monosubstituted compounds of Formula I, it is preferred if the radical R₃ is an alkyl radical, while R₁, R₂, R₄, and R₅ stand for H (para substitution).

In the context of the present invention, particularly preferred aromatic sulfonates are toluene-, cumene- or xylene sulfonate. Of the two industrially available toluene sulfonates (ortho and para toluenesulfonate), the para-isomer is preferred in the context of the present invention. For the cumenesulfonates, the para-isopropyl benzenesulfonate is also the preferred compound. As industrial xylene is mostly used as its mixture of isomers, the industrially available xylene sulfonate is also a mixture of several compounds that result from the sulfonation of ortho, meta and para-xylene. In these mixtures of isomers, compounds predominate in which each of the following radicals stand for methyl groups in the general Formula I (all other radicals stand for H). R₁ and R₂, R₁ and R₄, R₁ and R₃ as well as R₁ and R₅. Accordingly, xylene sulfonates are preferred with at least one methyl group ortho to the sulfonate group.

In the above-cited general Formula, X stands for a cation, for example an alkali metal cation such as sodium or potassium. X can also stand for the equivalently charged ratios of a multivalent cation, for example Mg²⁺/2 or Al³⁺/3, the sodium cation being preferred among the cited cations.

According to the invention, the sulfonates are preferably added in quantities from 0.2 to 10 wt. %, preferably from 0,3 to 5 wt. % and especially from 0,5 to 3 wt. %, each based on the rinsing agent.

Builders play a particularly important role in the automatic dishwasher agents according to the invention. They may contain any of the builders typically used in detergents, i.e. in particular, silicates, carbonates, organic co builders and also phosphates.

Suitable crystalline, layered sodium silicates correspond to the general formula NaMSiₓO2ₓ₊₁.H₂O, wherein M is sodium or hydrogen, x is a number from 1.9 to 4 and y is a number from 0 to 20, preferred values for x being 2, 3 or 4. Preferred crystalline, layered silicates corresponding to the above formula are those in which M is sodium and x assumes the value 2 or 3. Both β- and δ-sodium disilicates Na₂Si₂O₅.yH₂O are particularly preferred.

Other useful builders are amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can have been obtained in various ways, for example by surface treatment, compounding, compressing/compacting or by over drying. In the context of the invention, the term “amorphous” is also understood to encompass “X-ray amorphous”. In other words, the silicates do not produce any of the sharp X-ray reflexes typical of crystalline substances in X-ray diffraction experiments, but at best one or more maxima of the scattered X-radiation, which have a width of several degrees of the diffraction angle. However, particularly good builder properties may even be achieved where the silicate particles produce indistinct or even sharp diffraction maxima in electron diffraction experiments. This can be interpreted to mean that the products have microcrystalline regions between 10 and a few hundred nm in size, values of up to at most 50 nm and especially up to at most 20 nm being preferred. Especially preferred are densified/compacted amorphous silicates, compounded amorphous silicates and over dried X-ray amorphous silicates.

The generally known phosphates may of course also be used as builders providing their use should not be avoided on ecological grounds. Among the large number of commercially available phosphates, alkali metal phosphates have the greatest importance in the detergent industry, pentasodium triphosphate and pentapotassium triphosphate (sodium and potassium tripolyphosphate) being particularly preferred.

“Alkali metal phosphates” is the collective term for the alkali metal (more particularly sodium and potassium) salts of the various phosphoric acids, including metaphosphoric acids (HPO₃)ₙ and orthophosphoric acid (H₃PO₄) and representatives of higher molecular weight. The phosphates combine several advantages: they act as alkalinity sources, prevent lime deposits on machine parts and lime incrustations in fabrics and, in addition, contribute towards the cleaning effect.

Sodium dihydrogen phosphate NaH₂PO₄ exists as the dihydrate (density 1.91 gcm⁻³, melting point 60° C.) and as the monohydrate (density 2.04 gcm⁻³). Both salts are white, readily water-soluble powders that on heating, lose the water of crystallization and at 200° C. are converted into the weakly acidic diphosphate (disodium hydrogen diphosphate, Na₂H2P₂O₇) and, at higher temperatures into sodium trimetaphosphate (Na₃P3O₉) and Maddrell's salt (see below). NaH₂PO₄ shows an acidic reaction. It is formed by adjusting phosphoric acid with sodium hydroxide to a pH value of 4.5 and spraying the resulting “mash”. Potassium dihydrogen phosphate (primary or monobasic potassium phosphate, potassium biphosphate, KDP), KH₂PO₄, is a white salt with a density of 2.33 g^{cm-3}, has a melting point of 253° C. [decomposition with formation of potassium polyphosphate (KPO₃)ₓ] and is readily soluble in water.

Disodium hydrogen phosphate (secondary sodium phosphate), Na₂HPO₄, is a colorless, readily water-soluble crystalline salt. It exists in anhydrous form and with 2 mol (density 2.066 gcm⁻³, water loss at 95° C.), 7 mol (density 1.68 gcm⁻³, melting point 48° C. with loss of 5H₂O) and 12 mol of water (density 1.52 gcm⁻³, melting point 35° C. with loss of 5H₂), becomes anhydrous at 100° C. and, on fairly intensive heating, is converted into the diphosphate Na₄P₂O₇. Disodium hydrogen phosphate is prepared by neutralization of phosphoric acid with soda solution using phenolphthalein as indicator. Dipotassium hydrogen phosphate (secondary or dibasic potassium phosphate), K₂HPO₄, is an amorphous white salt, which is readily soluble in water.

Trisodium phosphate, tertiary sodium phosphate, Na₃PO₄, consists of colorless crystals with a density of 1.62 gcm⁻³ and a melting point of 73-76° C. (decomposition) as the dodecahydrate, a melting point of 100° C. as the decahydrate (corresponding to 19-20% P₂O₅) and a density of 2.536 gcm⁻³ in anhydrous form (corresponding to 39-40% P₂O₅). Trisodium phosphate is readily soluble in water through an alkaline reaction and is prepared by concentrating a solution of exactly 1 mole of disodium phosphate and 1 mole of NaOH by evaporation. Tripotassium phosphate (tertiary or tribasic potassium phosphate), K₃PO₄, is a white deliquescent granular powder with a density of 2.56 gcm⁻³, has a melting point of 1340° C. and is readily soluble in water through an alkaline reaction. It is formed, for example, when Thomas slag is heated with coal and potassium sulfate. Despite their higher price, the more readily soluble and therefore highly effective potassium phosphates are often preferred to corresponding sodium compounds in the detergent industry.

Tetrasodium diphosphate (sodium pyrophosphate), Na₄P₂O₇, exists in anhydrous form (density 2.534 gcm⁻³, melting point 988° C., a figure of 880° C. has also been mentioned) and as the decahydrate (density 1.815-1.836 gcm⁻³, melting point 94° C. with loss of water). Both substances are colorless crystals, which dissolve in water through an alkaline reaction. Na₄P₂O₇ is formed when disodium phosphate is heated to more than 200° C. or by reacting phosphoric acid with soda in a stoichiometric ratio and spray drying the solution. The decahydrate complexes heavy metal salts and hardness salts and, hence, reduces the hardness of water. Potassium diphosphate (potassium pyrophosphate), K₄P₂O₇, exists in the form of the trihydrate and is a colorless hygroscopic powder with a density of 2.33 gcm⁻³, is soluble in water, the pH of a 1% solution at 25° C. being 10.4.

Relatively high molecular weight sodium and potassium phosphates are formed by condensation of NaH₂PO₄ or KH₂PO₄. They may be divided into cyclic types, namely the sodium and potassium metaphosphates, and chain types, the sodium and potassium polyphosphates. The chain types in particular are known by various different names: fused or calcined phosphates, Graham's salt, Kurrol's salt and Maddrell's salt. All higher sodium and potassium phosphates are known collectively as condensed phosphates.

The industrially important pentasodium triphosphate, Na₅P₃O₁₀ (sodium tripolyphosphate), is anhydrous or crystallizes with 6H₂O to a non-hygroscopic, white, water-soluble salt, which has the general formula NaO—[P(O)(ONa)—O]ₙ—Na where n=3. Around 17 g of the salt, free from water of crystallization dissolve in 100 g of water at room temperature, around 20 g at 60° C. and around 32 g at 100° C. After heating the solution for 2 hours to 100° C., around 8% orthophosphate and 15% diphosphate are formed by hydrolysis. In the preparation of pentasodium triphosphate, phosphoric acid is reacted with soda solution or sodium hydroxide in a stoichiometric ratio and the solution is spray dried. Similarly to Graham's salt and sodium diphosphate, pentasodium triphosphate dissolves many insoluble metal compounds (including lime soaps, etc.). Pentapotassium triphosphate, K₅P₃O₁₀ (potassium tripolyphosphate), is marketed for example in the form of a 50% by weight solution (>23% P₂O5, 25% K₂O). The potassium polyphosphates are widely used in the detergent industry. Sodium potassium tripolyphosphates, which may also be used in accordance with the present invention, also exist. They are formed for example when sodium trimetaphosphate is hydrolyzed with KOH:
(NaPO₃)₃+2 KOH→Na₃K₂P₃O₁₀+H₂O

According to the invention, they may be used in exactly the same way as sodium tripolyphosphate, potassium tripolyphosphate or mixtures thereof. Mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate may also be used in accordance with the invention.

Organic co builders, which may be used in the automatic dishwasher agents according to the invention, include, in particular, polycarboxylates/polycarboxylic acids, polymeric polycarboxylates, aspartic acid, polyacetals, dextrins, other organic co builders (see below) and phosphonates. These classes of substances are described in the following.

Useful organic builders are, for example, the polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), providing its use is not ecologically unsafe, and mixtures thereof. Preferred salts are the salts of the polycarboxylic acids, such as citric acid, adipic acid, succinic acid, glutaric acid, tartaric acid, sugar acids and mixtures thereof.

The acids per se may also be used. Besides their building effect, the acids also typically have the property of an acidifying component and, hence also serve to establish a relatively low and mild pH in detergents or cleaners. Citric acid, succinic acid, glutaric acid, adipic acid, gluconic acid and mixtures thereof are particularly mentioned in this regard.

Other suitable builders are polymeric polycarboxylates, i.e. for example, the alkali metal salts of polyacrylic or polymethacrylic acid, for example those with a relative molecular weight of 500 to 70000 g/mol.

The molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ distinctly from the molecular weights measured against polystyrene sulfonic acids as standard. The molecular weights measured against polystyrene sulfonic acids are generally higher than the molecular weights mentioned in this specification.

Particularly suitable polymers are polyacrylates, which preferably have a molecular weight of 2000 to 20 000 g/mol. By virtue of their superior solubility, preferred representatives of this group are the short-chain polyacrylates, which have molecular weights of 2000 to 10 000 g/mol and, more particularly, 3000 to 5000 g/mol.

Also suitable are copolymeric polycarboxylates, particularly those of acrylic acid with methacrylic acid and those of acrylic acid or methacrylic acid with maleic acid. Acrylic acid/maleic acid copolymers containing 50 to 90% by weight of acrylic acid and 50 to 10% by weight of maleic acid have proved to be particularly suitable. Their relative molecular weights, based on the free acids, are generally in the range from 2000 to 70 000 g/mol, preferably in the range from 20 000 to 50 000 g/mol and more preferably in the range from 30 000 to 40 000 g/mol.

The (co)polymeric polycarboxylates may be used either in powder form or in the form of an aqueous solution. The content of (co)polymeric polycarboxylates in the detergents is preferably 0.5 to 20% by weight and more particularly 3 to 10% by weight.

Other particularly preferred polymers are biodegradable polymers of more than two different monomer units, for example those which contain salts of acrylic acid and maleic acid and vinyl alcohol or vinyl alcohol derivatives as monomers or those which contain salts of acrylic acid and 2-alkylallylsulfonic acid and sugar derivatives as monomers.

Other preferred copolymers are those, which preferably contain acrolein and acrylic acid/acrylic acid salts or acrolein and vinyl acetate as monomers.

Other preferred builders are polymeric aminodicarboxylic acids, salts or precursors thereof. Polyaspartic acids or salts and derivatives thereof, which have a bleach stabilizing effect besides their co builder properties, are particularly preferred.

Other suitable builders are polyacetals, which may be obtained by reaction of dialdehydes with polyol carboxylic acids containing 5 to 7 carbon atoms and at least three hydroxyl groups. Preferred polyacetals are obtained from dialdehydes, such as glyoxal, glutaraldehyde, terephthalaldehyde and mixtures thereof and from polyol carboxylic acids, such as gluconic acid and/or glucoheptonic acid.

Other suitable organic builders are dextrins, for example oligomers or polymers of carbohydrates, which may be obtained by partial hydrolysis of starches. The hydrolysis may be carried out by standard methods, for example acid- or enzyme-catalyzed methods. The end products are preferably hydrolysis products with average molecular weights of 400 to 500 000 g/mol. A polysaccharide with a dextrose equivalent (DE) of 0.5 to 40 and, more particularly, 2 to 30 is preferred, the DE being an accepted measure of the reducing effect of a polysaccharide by comparison with dextrose which has a DE of 100. Both maltodextrins with a DE of 3 to 20 and dry glucose syrups with a DE of 20 to 37 and also so-called yellow dextrins and white dextrins with relatively high molecular weights of 2000 to 30 000 g/mol may be used.

The oxidized derivatives of such dextrins are their reaction products with oxidizing agents that are capable of oxidizing at least one alcohol function of the saccharide ring to the carboxylic acid function. An oxidized oligosaccharide is also suitable. A product oxidized at C₆ of the saccharide ring can be particularly advantageous.

Other suitable co-builders are oxydisuccinates and other derivatives of disuccinates, preferably ethylenediamine disuccinate. Ethylenediamine-N,N′-disuccinate (EDDS) is preferably used in the form of its sodium or magnesium salts. Glycerol disuccinates and glycerol trisuccinates are also preferred in this connection. The quantities used in zeolite-containing and/or silicate-containing formulations are from 3 to 15% by weight.

Other useful organic co-builders are, for example, acetylated hydroxycarboxylic acids and salts thereof which may optionally be present in lactone form and which contain at least 4 carbon atoms, at least one hydroxy group and at most two acid groups.

Another class of substances with co-builder properties are the phosphonates, more particularly hydroxyalkane and aminoalkane phosphonates. Among the hydroxyalkane phosphonates, 1-hydroxyethane-1,1-diphosphonate (HEDP) is particularly important as a co-builder. It is preferably used in the form of the sodium salt, the disodium salt showing a neutral reaction and the tetrasodium salt an alkaline reaction (pH 9). Preferred aminoalkane phosphonates are ethylenediamine tetramethylene phosphonate (EDTMP), diethylenetriamine pentamethylenephosphonate (DTPMP) and higher homologs thereof. They are preferably used in the form of the neutrally reacting sodium salts, for example as the hexasodium salt of EDTMP or as the hepta- and octasodium salts of DTPMP. Of the phosphonates, HEDP is preferably used as a builder. In addition, the aminoalkane phosphonates have a pronounced heavy metal binding capacity. Accordingly, it can be of advantage, particularly where the agents also contain bleach, to use aminoalkane phosphonates, more particularly DTPMP, or mixtures of the phosphonates mentioned.

In addition, any compounds capable of forming complexes with alkaline earth metal ions may be used as co-builders.

Among the compounds yielding H₂O₂ in water, which serve as bleaching agents, sodium perborate tetrahydrate and sodium perborate monohydrate are particularly important. Other useful bleaching agents are, for example, sodium percarbonate, peroxypyrophosphates, citrate perhydrates and H₂O₂-yielding peracidic salts or peracids, such as perbenzoates, peroxyphthalates, diperazelaic acid, phthaloiminoperacid or diperdodecanedioic acid. Detergents according to the invention may also contain bleaching agents from the group of organic bleaches. Typical organic bleaching agents are diacyl peroxides, such as dibenzoyl peroxide for example. Other typical organic bleaching agents are the peroxy acids, of which alkyl peroxy acids and aryl peroxy acids are particularly mentioned as examples. Preferred representatives are (a) peroxybenzoic acid and ring-substituted derivatives thereof, such as alkyl peroxybenzoic acids, but also peroxy α-naphthoic acid and magnesium monoperphthalate, (b) aliphatic or substituted aliphatic peroxy acids, such as peroxylauric acid, peroxystearic acid, ε-phthalimidoperoxycaproic acid [phthaloiminoperoxyhexanoic acid (PAP)], o-carboxybenzamidoperoxycaproic acid, N-nonenylamido peradipic acid and N-nonenylamido persuccinates and (c) aliphatic and araliphatic peroxydicarboxylic acids, such as 1,12-diperoxycarboxylic acid, 1,9-diperoxyazelaic acid, diperoxysebacic acid, diperoxybrassylic acid, diperoxyphthalic acids, 2-decyldiperoxybutane-1,4-dioic acid, N,N-terephthaloyl-di(6-aminopercaproic acid).

Other suitable bleaching agents in the detergents according to the invention are chlorine- and bromine-releasing substances. Suitable chlorine- or bromine-releasing materials are, for example, heterocyclic N-bromamides and N-chloramides, for example trichloroisocyanuric acid, tribromoisocyanuric acid, dibromoisocyanuric acid and/or dichloroisocyanuric acid (DICA) and/or salts thereof with cations such as potassium and sodium. Hydantoin compounds, such as 1,3-dichloro-5,5-dimethyl hydantoin, are also suitable.

The cited bleaching agents can also be added to achieve a post-bleaching effect in the rinsing step.

Bleach activators, which support the action of the bleaching agents, are other important ingredients. Known bleach activators are compounds, which contain one or more N- or O-acyl groups, such as substances from the class of anhydrides, esters, imides and acylated imidazoles or oximes. Examples are tetraacetyl ethylenediamine (TAED), tetraacetyl methylenediamine (TAMD) and tetraacetyl hexylenediamine (TAHD) and also pentaacetyl glucose (PAG), 1,5-diacetyl-2,2-dioxohexahydro-1,3,5-triazine (DADHT) and isatoic anhydride (ISA).

Suitable bleach activators are compounds which form aliphatic peroxycarboxylic acids containing preferably 1 to 10 carbon atoms and more preferably 2 to 4 carbon atoms and/or optionally substituted perbenzoic acid under perhydrolysis conditions. Substances bearing O- and/or N-acyl groups with the number of carbon atoms mentioned and/or optionally substituted benzoyl groups are suitable. Preferred bleach activators are polyacylated alkylenediamines, more particularly tetraacetyl ethylenediamine (TAED), acylated triazine derivatives, more particularly 1,5-diacetyl-2,4-dioxohexahydro-1,3,5-triazine (DADHT), acylated glycolurils, more particularly tetraacetyl glycoluril (TAGU), N-acylimides, more particularly N-nonanoyl succinimide (NOSI), acylated phenol sulfonates, more particularly n-nonanoyl- or iso-nonanoyl-oxybenzenesulfonate (n- or iso-NOBS), carboxylic anhydrides, more particularly phthalic anhydride, acylated polyhydric alcohols, more particularly triacetin, ethylene glycol diacetate, 2,5-diacetoxy-2,5-dihydrofuran, n-methyl morpholinium acetonitrile methyl sulfate (MMA), acetylated sorbitol and mannitol and the mixtures thereof (SORMAN), acylated sugar derivatives, more particularly pentaacetyl glucose (PAG), pentaacetyl fructose, tetraacetyl xylose and octaacetyl lactose, and acetylated, optionally N-alkylated glucamine and gluconolactone, and/or N-acylated lactams, for example N-benzoyl caprolactam. Substituted hydrophilic acyl acetals and acyl lactams are also preferably used. Combinations of conventional bleach activators may also be used.

Bleach activators from the group of polyacylated alkylenediamines, more particularly tetraacetyl ethylenediamine (TAED), N-acyl imides, more particularly N-nonanoyl succinimide (NOSI), acylated phenol sulfonates, more particularly n-nonanoyl- or iso-nonanoyl-oxybenzenesulfonate (n- or iso-NOBS), n-methyl morpholinium acetonitrile methyl sulfate (MMA) are preferably used, preferably in quantities of up to 10% by weight, more preferably in quantities of 0,1% by weight to 8% by weight, especially 2 to 8% by weight and, especially preferably 2 to 6% by weight, based on the agent as a whole.

In addition to, or instead of the conventional bleach activators mentioned above, so-called bleach catalysts may also be incorporated in the agents according to the invention. These substances are bleach-boosting transition metal salts or transition metal complexes such as, for example, manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands and cobalt-, iron-, copper- and ruthenium-ammine complexes may also be used as bleach catalysts.

Bleach-boosting transition metal complexes, more particularly containing the central atoms Mn, Fe, Co, Cu, Mo, V, Ti and/or Ru, preferably selected from the group of manganese and/or cobalt salts and/or complexes, particularly preferably the cobalt(ammine) complexes, cobalt(acetate) complexes, cobalt (carbonyl) complexes, chlorides of cobalt or manganese and manganese sulfate, are also present in typical quantities, preferably in a quantity of up to 5% by weight, especially in a quantity of 0.0025% by weight to 1% by weight and particularly preferably in a quantity of 0.01% by weight to 0.25% by weight, based on the detergent as a whole. In special cases, however, even more bleach activator may be used.

Glass corrosion inhibitors prevent the occurrence of smears, streaks and scratches as well as iridescence on the glass surface of glasses washed in an automatic dishwasher. Preferred glass corrosion inhibitors come from the group of magnesium and/or zinc salts and/or magnesium and/or zinc complexes.

A preferred class of compounds that can be used to prevent glass corrosion are insoluble zinc salts. In terms of the preferred embodiment, insoluble zinc salts are zinc salts with a solubility of maximum 10 grams zinc salt per liter of water at 20° C. According to the invention, examples of particularly preferred insoluble zinc salts are zinc silicate, zinc carbonate, zinc oxide, basic zinc carbonate (Zn₂(OH)₂CO₃), zinc hydroxide, zinc oxalate, zinc monophosphate (Zn₃(PO₄)₂), and zinc pyrophosphate (Zn₂(P₂O₇)).

The cited zinc compounds are preferably used in quantities that produce an amount of zinc ions in the agent between 0.02 and 10 wt. %, preferably between 0.1 and 5.0 wt. % and especially between 0.2 and 1.0 wt. %, based on the total agent containing the glass corrosion inhibitor. The exact content of the zinc salt or zinc salts in the agent naturally depends on the type of zinc salt—the lower the solubility of the added zinc salt, the higher must be its concentration in the agents.

As for the most part the insoluble zinc salts remain unchanged during the dishwasher process, the particle size of the salts is an important criteria for the salts not to stick to the glasswares or machine parts. Agents are preferred in which the insoluble zinc salts have a particle size below 1.7 mm. When the maximum particle size of the insoluble zinc salt lies below 1.7 mm, one need not worry about insoluble residues in the dishwasher. Preferably, in order to further minimize the danger of insoluble residues, the insoluble zinc salt has an average particle size that lies markedly below this value, for example an average particle size of less than 250 μm. This is increasingly true as the solubility of the zinc salt decreases. In addition, the glass corrosion inhibiting efficiency increases with decreasing particle size. For zinc salts with very low solubility, the particle size preferably lies below 100 μm. For zinc salts with even lower solubility, the particle size can lie even lower; for example for the very badly soluble zinc oxide, the particle size preferably lies below 100 μm.

A further preferred class of compounds consists of magnesium and/or zinc salt(s) of at least one monomeric and/or polymeric organic acid. These ensure that even on repeated use, the surfaces of the glassware are not corroded, especially that no smears, streaks and scratches or iridescence occur on the glass surfaces.

Although any magnesium and/or zinc salt(s) of monomeric and/or polymeric organic acids can be used, the magnesium and/or zinc salt(s) of monomeric and/or polymeric organic acids from the groups of the non-branched, saturated or unsaturated monocarboxylic acids, the branched, saturated or unsaturated monocarboxylic acids, the saturated and unsaturated dicarboxylic acids, the aromatic mono-, di- and tricarboxylic acids, the sugar acids, the hydroxy acids, the oxoacids, the amino acids and/or the polymeric carboxylic acids are however preferred. The spectrum of the inventive preferred zinc salts of organic acids, preferably organic carboxylic acids, ranges from salts that are difficultly soluble or insoluble in water, i.e. with a solubility below 100 mg/l, preferably below 10 mg/l, or especially are insoluble, to such salts with solubilities in water greater than 100 mg/l, preferably over 500 mg/l, particularly preferably over 1 g/l and especially over 5 g/l (all solubilities at a water temperature of 20° C.). The first group of zinc salts includes zinc citrate, zinc oleate and zinc stearate, the group of soluble zinc salts includes for example, zinc formate, zinc acetate, zinc lactate und zinc gluconate.

A particular advantageous glass corrosion inhibitor is a zinc salt of an organic carboxylic acid, particularly preferably a zinc salt from the group zinc stearate, zinc oleate, zinc gluconate, zinc acetate, zinc lactate and/or zinc citrate. Zinc ricinolate, zinc abietate and zinc oxalate are also preferred.

In the context of the present invention, the content of zinc salt in the detergent is preferably between 0.1 and 5 wt. %, preferably between 0.2 and 4.0 wt. % and especially between 0.4 and 3 wt. %, and the content of zinc in the oxidized form (calculated as Zn²⁺) between 0.01 and 1 wt. %, preferably between 0.02 and 0.5 wt. % and especially between 0.04 and 0.2 wt. % respectively, based on the total weight of the agent containing the glass corrosion inhibitor.

Enzymes suitable for use in the detergents according to the invention are, in particular, those from the classes of hydrolases, such as proteases, esterases, lipases or lipolytic enzymes, amylases, glycosyl hydrolases and mixtures thereof. The enzymes can be adsorbed on carrier substances or embedded in coating substances in order to protect them from premature decomposition. The proportion of enzymes, enzyme mixtures or enzyme granules can for example, be about 0.1 to 5% by weight, preferably 0.5 to about 4.5% by weight.

A protein and/or enzyme in an inventive agent can be protected, particularly in storage, against deterioration such as, for example inactivation, denaturation or decomposition, for example through physical influences, oxidation or proteolytic cleavage. An inhibition of the proteolysis is particularly preferred during microbial preparation of proteins and/or enzymes, particularly when the compositions also contain proteases. Preferred compositions according to the invention comprise stabilizers for this purpose.

One group of stabilizers are reversible protease inhibitors. For this, benzamnidine hydrochloride, borax, boric acids, boronic acids or their salts or esters are frequently used, above all derivatives with aromatic groups, for example ortho, meta or para substituted phenyl boronic acids, particularly 4-formylphenyl boronic acid or the salts or esters of the cited compounds. Peptide aldehydes, i.e. oligopeptides with a reduced C-terminus, particularly those from 2 to 50 monomers are also used for this purpose. Ovomucoid and leupeptin, among others, belong to the peptidic reversible protease inhibitors. Specific, reversible peptide inhibitors for the protease subtilisin and fusion proteins from proteases and specific peptide inhibitors are also suitable.

Further enzyme stabilizers are amino alcohols like mono-, di-, triethanol- and -propanolamine and their mixtures, aliphatic carboxylic acids up to C₁₂, such as for example succinic acid, other dicarboxylic acids or salts of the cited acids. End-capped fatty acid amide alkoxylates are also suitable for this purpose. Certain organic acids used as builders can, as disclosed in WO 97/18287 additionally stabilize an included enzyme.

Lower aliphatic alcohols, but above all polyols such as, for example glycerol, ethylene glycol, propylene glycol or sorbitol are further frequently used enzyme stabilizers. Di-glycerol phosphate also protects against denaturation by physical influences. Similarly, calcium and/or magnesium salts are used, such as, for example calcium acetate or calcium formate.

Polyamide oligomers or polymeric compounds like lignin, water-soluble vinyl copolymers or cellulose ethers, acrylic polymers and/or polyamides stabilize enzyme preparations against physical influences or pH variations. Polymers containing polyamine-N-oxide act simultaneously as enzyme stabilizers and color transfer inhibitors. Other polymeric stabilizers are linear C₈-C₁₈ polyoxyalkylenes. Alkyl polyglycosides can also stabilize the enzymatic components of the inventive agents and advantageously induce them, in addition, to increase in performance. Crosslinked nitrogen-containing compounds chiefly perform a dual function as soil release agents and as enzyme stabilizers. Hydrophobic non-ionic polymer stabilizes in particular an optionally present cellulase.

Reducing agents and antioxidants increase the stability of enzymes against oxidative decomposition; sulfur-containing reducing agents are commonly used here. Other examples are sodium sulfite and reducing sugars.

The use of combinations of stabilizers is particularly preferred, for example of polyols, boric acid and/or borax, the combination of boric acid or borate, reducing salts and succinic acid or other dicarboxylic acids or the combination of boric acid or borate with polyols or polyamino compounds and with reducing salts. The effect of peptide-aldehyde stabilizers is conveniently increased by the combination with boric acid and/or boric acid derivatives and polyols and still more by the additional effect of divalent cations, such as for example calcium ions.

Colorants and fragrances may be added to the automatic dishwasher agents according to the invention in order to improve the aesthetic impression created by the products and to provide the consumer not only with the required performance but also with a visually and sensorially typical and unmistakable product.

Colorants and fragrances may be added to the automatic dishwasher agents according to the invention in order to improve the aesthetic impression created by the products and to provide the consumer not only with the required performance but also with a visually and sensorially typical and unmistakable product. Suitable perfume oils or fragrances include individual perfume compounds, for example synthetic products of the ester, ether, aldehyde, ketone, alcohol and hydrocarbon type. Perfume compounds of the ester type are, for example, benzyl acetate, phenoxyethyl isobutyrate, p-tert.butyl cyclohexyl acetate, linalyl acetate, dimethyl benzyl carbinyl acetate, phenyl ethyl acetate, linalyl benzoate, benzyl formate, ethyl methyl phenyl glycinate, allyl cyclohexyl propionate, styrallyl propionate and benzyl salicylate. The ethers include, for example, benzyl ethyl ether; the aldehydes include, for example, the linear alkanals containing 8 to 18 carbon atoms, citral, citronellal, citronellyloxyacetaldehyde, cyclamen aldehyde, hydroxycitronellal, lilial and bourgeonal; the ketones include, for example, the ionones, α-isomethyl ionone and methyl cedryl ketone; the alcohols include anethol, citronellol, eugenol, geraniol, linalool, phenyl ethyl alcohol and terpineol and the hydrocarbons include, above all, the terpenes, such as limonene and pinene. However, mixtures of various perfumes, which together produce an attractive perfume note, are preferably used. Perfume oils such as these may also contain natural perfume mixtures obtainable from vegetal sources, for example pine, citrus, jasmine, patchouli, rose or ylang-ylang oil. Also suitable are clary oil, camomile oil, clove oil, melissa oil, mint oil, cinnamon leaf oil, lime blossom oil, juniper berry oil, vetivert oil, olibanum oil, galbanum oil and ladanum oil and orange blossom oil, neroli oil, orange peel oil and sandalwood oil.

The fragrances may be directly incorporated in the detergents according to the invention, although it can also be of advantage to apply the fragrances on carriers. Suitable carrier materials are, for example, cyclodextrins, the cyclodextrin/perfume complexes optionally being coated with other auxiliaries. The perfumes may also be incorporated in the agent according to the invention and lead to a perfume impression when the machine is opened (see above).

In order to improve their aesthetic impression, the manufactured agents according to the invention (or parts thereof) may be colored with suitable colorants. Preferred colorants, which are not difficult for the expert to choose, have high storage stability, are not affected by the other ingredients of the detergents or by light and do not have any pronounced substantivity for the substrates being treated, such as glass, ceramics or plastic tableware, so as not to color them.

To protect the tableware or the machine itself, the detergents according to the invention may contain corrosion inhibitors, silver protectors being particularly important for automatic dishwashers. Substances known from the prior art may be used. Above all, silver protectors selected from the group of triazoles, benzotriazoles, bisbenzotriazoles, aminotriazoles, alkylaminotriazoles and the transition metal salts or complexes may generally be used. Benzotriazole and/or alkylaminotriazole are particularly preferred. In addition, detergent formulations often contain corrosion inhibitors containing active chlorine, which are capable of distinctly reducing the corrosion of silver surfaces. Chlorine-free detergents contain in particular oxygen- and nitrogen-containing organic redox active compounds, such as dihydric and trihydric phenols, for example hydroquinone, pyrocatechol, hydroxyhydroquinone, gallic acid, phloroglucinol, pyrogallol and derivatives of these compounds. Salt-like and complex-like inorganic compounds, such as salts of the metals Mn, Ti, Zr, Hf, V, Co and Ce are also frequently used. Of these, the transition metal salts selected from the group of manganese and/or cobalt salts and/or complexes are preferred, cobalt(ammine) complexes, cobalt(acetate) complexes, cobalt(carbonyl) complexes, chlorides of cobalt or manganese and manganese sulfate being particularly preferred. Zinc compounds may also be used to prevent corrosion of tableware.

The agents according to the invention can be packaged immediately following their manufacture and be sold as particulate detergents. It is however possible to compress the agent into detergent tablets or individual phases thereof, so as to be able to provide the consumer with the compact commercial shape. Automatic dishwasher agents, characterized in that they exist in the form of a tablet, preferably in the form of a multi-phase tablet in which the content of rinse surfactant in the individual phases differs, are further preferred embodiments of the present invention.

Here, multi-phase tablets are particularly preferred, the multi-layer tablets being especially important due to their relative ease of manufacture. In the context of the present invention, the individual phases of the tablet can have different three-dimensional forms. The simplest embodiment is a two-layer or multilayer tablet in which each layer represents a phase. However, it is also possible in accordance with the invention to produce multiphase tablets in which individual phases assume the form of dispersions in (an)other phase(s). Besides so-called “ring/core” tablets, shell tablets, for example, or combinations of the embodiments mentioned are possible.

The tablets according to the invention may assume any geometric form, concave, convex, biconcave, biconvex, cubic, tetragonal, orthorhombic, cylindrical, spherical, cylinder-segment-like, disk-shaped, tetrahedral, dodecahedral, octahedral, conical, pyramidal, ellipsoidal, pentagonal-, heptagonal- and octagonal-prismatic and rhombohedral forms being particularly preferred. Completely irregular bases, such as arrow and animal shapes, trees, clouds etc. can also be produced. If the tablets according to the invention have corners and edges, they are preferably rounded off. As an additional optical differentiation, an embodiment with rounded-off corners and beveled (“chamfered”) edges is preferred.

Instead of the layered structure, tablets can also be made which contain the rinse surfactants. It has also proved possible to produce a basic tablet with one or more cavity(ies) and to either add the sulfonic acid-containing copolymers directly to the basic tablet or, to subsequently fill the cavity. This manufacturing process provides preferably multi-phase detergent tablets that consist of a basic tablet with a cavity and a part that is at least partially contained in said cavity.

The cavity in the compressed part of such tablets according to the invention may assume any shape. It may extend throughout the tablet, i.e. may have an opening on various sides, for example at the top and bottom of the tablet, although it may also be a cavity which does not extend throughout the tablet, i.e. a cavity of which the opening is only visible on one side of the tablet. The shape of the cavity can also be freely selected within wide limits. In the interests of process economy, only holes, which open on opposite sides of the tablets and recesses, which open on one side, have proved successful. In preferred detergent tablets, the cavity is in the form of a hole opening on two opposite sides of the tablet. The shape of this hole may be freely selected, preferred tablets being characterized in that the hole has circular, ellipsoidal, triangular, rectangular, square, pentagonal, hexagonal, heptagonal or octagonal horizontal sections. The hole may also assume completely irregular shapes, such as arrow or animal shapes, trees, clouds, etc. As with the tablets, angular holes preferably have rounded-off corners and edges or rounded-off corners and chamfered edges are preferred.

The geometric forms mentioned above may be combined with one another as required. Thus, tablets with a rectangular or square base and circular holes can be produced just as well as round tablets with octagonal holes, the various combination possibilities being unlimited. In the interests of process economy and consumer acceptance, particularly preferred holed tablets are characterized in that the base of the tablet and the cross-section of the hole have the same geometric shape, for example tablets with a square base and a centrally located square hole. Ring tablets, i.e. circular tablets with a circular hole, are particularly preferred.

If the above-mentioned principle of the hole open on two opposite sides of the tablet is reduced to one opening, the result is a recess tablet. Detergent tablets according to the invention in which the cavity assumes the form of a recess are also preferred. As with the “hole tablets”, the tablets according to the invention may assume any geometric shape in this embodiment too, as described above.

The shape of the recess may also be freely selected, tablets in which at least one recess may assume a concave, convex, cubic, tetragonal, orthorhombic, cylindrical, spherical, cylinder-segment-like, disk-shaped, tetrahedral, dodecahedral, octahedral, conical, pyramidal, ellipsoidal, pentagonal-, heptagonal- and octagonal-prismatic and rhombohedral form being preferred. The recess may also assume a totally irregular shape, such as arrow or animal shapes, trees, clouds etc. As with the tablets, recesses with rounded-off corners and edges or with rounded-off corners and chamfered edges are preferred.

The size of the recess or the hole by comparison with the tablet as a whole is governed by the application envisaged for the tablets. The size of the cavity can vary according to how much more active substance needs to be filled in the remaining volume.

In preferred embodiments of the present invention, the basic tablet has a high specific gravity, for example above 1.000 kgdm⁻³, preferably above 1.025 kgdm⁻³, more preferably above 1.050 kgdm⁻³ and most preferably above 1.100 kgdm⁻³.

In order to facilitate the disintegration of heavily compacted tablets, disintegration aids, so-called tablet disintegrators, may be incorporated in the basic tablets to shorten their disintegration times. According to Römpp (9th Edition, Vol. 6, page 4440) and Voigt “Lehrbuch der pharmazeutischen Technologie” (6th Edition, 1987, pages 182-184), tablet disintegrators or disintegration accelerators are auxiliaries, which promote the rapid disintegration of tablets in water or gastric juices and the release of the pharmaceuticals in an absorbable form.

These substances, which are also known as “disintegrators” by virtue of their effect, increase in volume on contact with water so that, firstly, their own volume increases (swelling) and secondly, a pressure can also be generated by the release of gases, causing the tablet to disintegrate into smaller particles. Well-known disintegrators are, for example, carbonate/citric acid systems, although other organic acids may also be used. Swelling disintegration aids are, for example, synthetic polymers, such as polyvinyl pyrrolidone (PVP), or natural polymers and modified natural substances, such as cellulose and starch and derivatives thereof, alginates or casein derivatives.

In the context of the present invention, preferred disintegrators that are used are based on cellulose, and therefore the preferred detergent tablets comprise such a cellulose-based disintegrator in quantities from 0.5 to 10% by weight, preferably 3 to 7% by weight and especially 4 to 6% by weight.

The agents according to the invention may comprise a gas-evolving effervescent system as an alternative or in addition to a swelling disintegrator. The gas-evolving effervescent system may consist of a single substance that releases a gas on contact with water. Among these compounds, particular mention is made of magnesium peroxide that releases oxygen on contact with water. However, the gas-releasing effervescent system normally consists of at least two constituents that react with one another to form a gas. Although various possible systems could be used, for example systems releasing nitrogen, oxygen or hydrogen, the effervescent system used in the detergent tablets according to the invention should be selected with both economic and ecological considerations in mind. Preferred effervescent systems consist of alkali metal carbonate and/or -hydrogen carbonate and an acidifying agent capable of releasing carbon dioxide from the alkali metal salts in aqueous solution.

Among the alkali metal carbonates and -hydrogen carbonates, the sodium and potassium salts are preferred to the other salts for reasons of cost. Of course, the pure alkali metal carbonates and hydrogen carbonates need not be used; in fact, mixtures of different carbonates and hydrogen carbonates may be preferred due to reasons of washing technology.

In preferred detergent tablets, 2 to 20% by weight, preferably 3 to 15% by weight and more preferably 5 to 10% by weight of an alkali metal carbonate or -hydrogen carbonate are used as the effervescent system, and 1 to 15, preferably 2 to 12 and more preferably 3 to 10% by weight of an acidifying agent, based on the tablet as a whole.

Suitable acidifying agents, which release carbon dioxide from the alkali metal salts in aqueous solution are, for example, boric acid and alkali metal hydrogen sulfates, alkali metal dihydrogen phosphates and other inorganic salts. Indeed, organic acidifying agents are preferably used, citric acid being a particularly preferred acidifying agent. However, other solid mono-, oligo- and polycarboxylic acids in particular may also be used. Within this group, tartaric acid, succinic acid, malonic acid, adipic acid, maleic acid, fumaric acid, oxalic acid and polyacrylic acid are preferred. Organic sulfonic acids, such as amidosulfonic acid, may also be used. Sokalan® DCS (trademark of BASF), a mixture of succinic acid (max. 31% by weight), glutaric acid (max. 50% by weight) and adipic acid (max. 33% by weight), is commercially available and may also be used with advantage as an acidifying agent for the purposes of the present invention.

According to the present invention, preferred detergent tablets are those in which a substance selected from the group of organic di-, tri- and oligocarboxylic acids or mixtures thereof is present as the acidifying agent in the effervescent system.

As can be inferred from the previous embodiments, those detergents or dishwasher agents are preferred in which the non-ionic surfactant or surfactant mixture of Formula I and the α-amylase are in the same phase.

Consequently, the object consisted in finding an α-amylase that is suitable for such agents, i.e. one, which is not significantly impaired in its activity by the other simultaneously active constituents. This object is achieved especially by means of suitable single-phase agents with the cited surfactant or surfactant mixture and the α-amylase according to SEQ ID NO. 1 or SEQ ID NO. 2.

Agents according to the invention are preferred, wherein R¹ in Formula I stands for an alkyl radical with 6 to 24, preferably 8 to 20, particularly preferably 9 to 15 and quite particularly preferably 9 to 11 carbon atoms.

They possess not only the cited advantageous effects but also are available, as mentioned, from natural sources in comparatively large amounts.

Those used up to now in the available detergents are preferred in which R² or R³ in Formula I stand for a radical —CH₃, w and x independently of one another stand for values of 3 or 4 and y and z independently of one another stand for values of 1 or 2.

An example of this is the above and inter alia the surfactant described in the example of the application DE 10136000 with the Formula
CH₃(CH₂)₁₀—O—(CH₂—CH₂—O)₃—(CH₂—CH(CH₃)—O)₃—(CH₂—CH₂—O)₂—(CH₂—CH(CH₃)—O)_{1,5}—H.

A further particularly preferred embodiment of the characterized surfactant of Formula I is available from Condea Company, Italy under the trade name Biodac/2-32, described chemically as C11 alcohol-ethoxylate/propoxylate with a cloud point of 34 to 36° C. in a 1% solution in water, a hydroxyl number from 85 to 90 mg KOH/g, a molecular weight of 623 to 660 g/mol and a pH from 4 to 7 in a 5% solution; in addition, it contains less than 0.5 wt. % water (Karl-Fischer) and less than 0.2 wt. % insoluble ash. These data refer to the substance available on 8.11.1999 under this specification.

Detergents constitute a preferred embodiment, which comprise as the non-ionic surfactant(s) F, a non-ionic surfactant of the general Formula
R¹O[CH₂CH(CH₃)O]ₓ[CH₂CH₂O]_{y}CH₂CH(OH)R²
in which R¹ stands for a linear or branched aliphatic hydrocarbon radical with 4 to 18 carbon atoms or mixtures thereof, R² means a linear or branched hydrocarbon radical with 2 to 26 carbon atoms or mixtures thereof and x stands for values between 0.5 and 1.5 and y stands for a value of at least 15.

The cited carbon chain lengths and alkoxylation degrees constitute statistical average values that can be a whole or a fractional number for a specific product. Due to the manufacturing process, commercial products of the cited formulae do not consist of one sole representative, but rather are a mixture, wherein not only the carbon chain lengths but also the ethoxylation or alkoxylation degrees can be average values and thus be fractional numbers. In the Table presented in the application DE 102004015392.2, 120 preferred representatives are described and itemized according to the radicals R¹ (linear, 8 to 10 carbon atoms) and R² (linear, 8 carbon atoms) as well as the indices x (1 or 2) and y (11 to 29). Preferred agents according to the invention comprise one or more surfactants from this summary.

Preferred among the non-ionic surfactants F of the general Formula R¹O[CH₂CH(CH₃)O]ₓ[CH₂CH₂O]_{y}CH₂CH(OH)R², are those in which R¹ stands for a saturated, non-branched, aliphatic hydrocarbon radical with 8 to 12 carbon atoms, preferably with 8 to 10 carbon atoms, further, R² stands for a saturated, linear hydrocarbon radical with 8 to 12 carbon atoms, preferably with 8 hydrocarbon radicals and in which x stands for values of 1 or 2, while y stands for values between 18 and 24, preferably for values between 20 and 24.

Detergents constitute a preferred embodiment, which comprise as the non-ionic surfactant(s) F, a non-ionic surfactant of the general Formula
R¹O[CH₂CH(R³)O]ₓR²
in which R¹ stands for linear or branched aliphatic hydrocarbon radicals with 1 to 30 carbon atoms, R² stands for linear or branched, saturated or unsaturated, aliphatic or aromatic hydrocarbon radicals with 1 to 30 carbon atoms, which have between 1 and 5 hydroxyl groups and in addition are preferably functionalized with an ether group, R³ stands for H or a methyl, ethyl, n-propyl, iso-propyl, n-butyl, 2-butyl or 2-methyl-2-butyl radical and x stands for a value between 1 and 40.

R can optionally be alkoxylated, wherein the alkoxy group is preferably selected from ethoxy, propoxy, butoxy groups and mixtures thereof.

Preferred surfactants corresponding to the above general formula are those in which R¹ is a C₉₋₁₁ or C₁₁₋₁₅ alkyl group, R³═H and x is a value of 8 to 15 whereas R² is preferably a linear or branched saturated alkyl radical. Particularly preferred surfactants may be represented by the formulae C₉₋₁₁(EO)₈—C(CH₃)₂CH₂CH₃, C₁₁₋₁₅(EO)₁₅(PO)₆-C₁₂₋₁₄, C₉₋₁₁(EO)₈(CH₂)₄CH₃.

Other suitable surfactants are mixed-alkoxylated surfactants, those containing butyloxy groups being preferred. Surfactants such as these may be represented by the following Formula
R¹(EO)ₐ(PO)_{b}(BO)_{c}
in which R¹ stands for a linear or branched, saturated or unsaturated, aliphatic or aromatic hydrocarbon radicals with 1 to 30, preferably 1 to 6 carbon atoms, a stands for values between 2 and 30, b for values between 0 and 30 and c for values between 1 and 30, preferably between 1 and 20.

Alternatively, the EO and PO groups in the above formula may also be interchanged so that surfactants corresponding to the following general Formula
R¹(PO)_{b}(EO)ₐ(BO)_{c},
in which R¹ stands for a linear or branched, saturated or unsaturated, aliphatic or aromatic hydrocarbon radical with 1 to 30, preferably 1 to 6 carbon atoms, a stands for values between 2 and 30, b for values between 0 and 30 and c for values between 1 and 30, preferably between 1 and 20, may also be used with advantage.

Particularly preferred representatives from this group of surfactants may be represented by the formulae C₉₋₁₁(PO)₃(EO)₁₃(BO)₁₅, C₉₋₁₁(PO)₃(EO)₁₃(BO)₆, C₉₋₁₁(PO)₃(EO)₁₃(BO)₃, C₉₋₁₁(EO)₁₃(BO)₆, C₉₋₁₁(EO)₁₃(BO)₃, C₉₋₁₁(PO)(EO)₁₃(BO)₃, C₉₋₁₁(EO)₈(BO)₃, C₉₋₁₁(EO)₈(BO)₂, C₁₂₋₁₅(EO)₇(BO)₂, C₉₋₁₁(EO)₈(BO)₂, C₉₋₁₁(EO)₈(BO). A particularly preferred surfactant with the formula C₁₃₋₁₅(EO)₉₋₁₀(BO)₁₋₂ is commercially available under the name Plurafac® LF 221. Another particularly preferred surfactant containing 10 EO and 2 BO is available under the trade name Genapol® 25 EB 102. A surfactant with the formula C₁₂₋₁₃(EO)₁₀(BO)₂ may also be used with advantage.

Detergents constitute a preferred embodiment, which comprise as the non-ionic surfactant(s) F, a non-ionic surfactant of the general Formula
R¹O[CH₂CH₂O]ₓCH₂CH(OH)R²
which in addition to a radical R¹, which stands for linear or branched, saturated or unsaturated aliphatic or aromatic hydrocarbon radicals with 1 to 30 carbon atoms, preferably with 4 to 20 carbon atoms, exhibits a linear or branched, saturated or unsaturated, aliphatic or aromatic hydrocarbon radical R² with 1 to 30 carbon atoms, which is neighbored by a monohydroxylated intermediate group —CH₂CH(OH)—, and in which x stands for values between 1 and 90.

Thereby, non-ionic surfactants corresponding to the above-cited Formula are particularly advantageous, which comprise, in addition to a radical R¹ that stands for corresponding hydrocarbon radicals with 4 to 22 carbon atoms, also have a corresponding hydrocarbon radical R² with 2 to 22 carbon atoms, and in which x stands for values between 40 and 80, preferably for values between 40 and 60.

The cited carbon chain lengths and the degree of alkoxylation again constitute statistical average values that can be a whole or a fractional number for a specific product. Due to the manufacturing process, commercial products of the cited formulae do not consist in the main of one sole representative, but rather are a mixture, wherein not only the carbon chain lengths but also the degree of alkoxylation can be average values and thus be fractional numbers. In the Table presented in the application DE 102004015392.2 there are presented 59 preferred representatives, which are itemized according to the radicals R¹ (linear, 8 to 10 carbon atoms) and R² (linear, 8 carbon atoms) as well as the index x (11 to 29). Preferred compositions according to the invention comprise one or more surfactants from this summary.

Such non-ionic surfactants F of the general Formula R¹O[CH₂CH₂O]ₓCH₂CH(OH)R², are preferred in which R¹ stands for a saturated, non-branched, aliphatic hydrocarbon radical with 8 to 12 carbon atoms, preferably with 10 carbon atoms, further, R² stands for a saturated, linear hydrocarbon radical with 8 to 12 carbon atoms, preferably with 8 hydrocarbon radicals, and in which x stands for values between 14 and 26, preferably for values between 20 and 24.

Detergents constitute a preferred embodiment, which comprise as the non-ionic surfactant F, a non-ionic surfactant of the general Formula 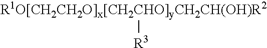
in which R¹ and R² independently of one another stand for a linear or branched, saturated or mono- or polyunsaturated hydrocarbon radical with 2 to 26 carbon atoms, R³ independently of one another is selected from —CH₃, —CH₂CH₃, —CH₂CH₂—CH₃ und CH(CH₃)₂, preferably however standing for —CH₃, and x and y independently of one another stand for values between 1 and 32, wherein non-ionic surfactants with values for x of 15 to 32 and y from 0.5 to 1.5 are quite particularly preferred.

Detergents constitute a preferred embodiment, which comprise as the non-ionic surfactant G, a non-ionic surfactant of the general Formula 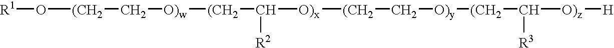
in which R¹ stands for a linear or branched, saturated or mono- or polyunsaturated C₆₋₂₄ alkyl or alkenyl radical, each group R² or R3 independently of one another is selected from —H, —CH₃—CH₂H₃, —CH₂CH₂—CH₃ and CH(CH₃)₂, and the indices w, x, y, z independently of one another stand for whole numbers from 1 to 6.

The manufacture of these non-ionic surfactants as well as preferred embodiments have already been given in relation to the component (aa) and are correspondingly valid in this situation. Similarly, the representatives summarized in the Table presented in the application DE 102004015392.2, corresponding to the numbers 121 to 1723 characterize preferred embodiments of the present application.

The component (ac) concerns a mixture of both the non-ionic surfactants F and G. The following has to be said about this combination.

In the context of this application, detergents, particularly automatic dishwasher agents are particularly preferred, which comprise a non-ionic surfactant F of the general Formula R¹O[CH₂CH₂O]ₓCH₂CH(OH)R², in which R¹ stands for a saturated, non-branched, aliphatic hydrocarbon radical with 8 to 12 carbon atoms, preferably with 10 carbon atoms, further, R² stands for a saturated, linear hydrocarbon radical with 8 to 12 carbon atoms, preferably with 8 hydrocarbon radicals, and in which x stands for values between 14 and 26, preferably for values between 20 and 24, in combination with a non-ionic surfactant G of the general Formula 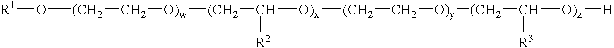
in which R¹ stands for a linear or branched, saturated or mono- or polyunsaturated C₆₋₂₄-alkyl or alkenyl radical, each group R² or R³ independently of one another is selected from —CH₃, —CH₂CH₃, —CH₂CH₂—CH₃, CH(CH₃)₂, and the indices w, x, y, z independently of one another stand for whole numbers from 1 to 6.

Further preferred are those detergents, particularly automatic dishwasher agents, which comprise a non-ionic surfactant F of the general Formula R¹O[CH₂CH(CH₃)O]ₓ[CH₂CH₂O]_{y}CH₂CH(OH)R² in which R¹ stands for a saturated, non-branched, aliphatic hydrocarbon radical with 8 to 12 carbon atoms, preferably with 8 to 10 carbon atoms, further, R² stands for a saturated, linear hydrocarbon radical with 8 to 12 carbon atoms, preferably with 8 hydrocarbon radicals, and in which x stands for values of 1 or 2, while y stands for values between 18 and 24, preferably for values between 20 and 24, in combination with a non-ionic surfactant G of the general Formula 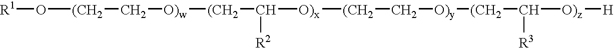
in which R¹ stands for a linear or branched, saturated or mono- or polyunsaturated C₆₋₂₄-alkyl or alkenyl radical, each group R² or R3 independently of one another is selected from —CH₃, —CH₂CH₃, —CH₂CH₂—CH₃, CH(CH₃)₂, and the indices w, x, y, z independently of one another stand for whole numbers from 1 to 6.

Detergents constitute a preferred embodiment, in which the surfactant system comprises the non-ionic surfactants F and G in a weight proportion F:G between 2:9 and 90:1, preferably between 1:3 and 80: 1, preferably 3:7 and 70: 1, particularly preferred between 7:13 and 60:1 and particularly between 2:3 and 50:1.

Regarding the amylase component, detergents according to the invention constitute preferred embodiments, wherein the α-amylase, in comparison with the α-amylase according to SEQ ID NO. 1 or SEQ ID NO. 2, is a modified α-amylase that can be derived by means of one of the following mutations or derivatizations of the α-amylase described by SEQ ID NO. 1 or SEQ ID NO. 2:
substitution of an amino acid
insertion of an amino acid
deletion of an amino acid
deletion of 2, 3, 4 or 5 amino acids at the C-terminus or at the N-terminus or
fusion with another polymer, preferably another enzyme.

Accordingly, an embodiment of the present application is constituted when simply one amino acid is exchanged for one other, i.e. is substituted in the α-amylase sequence given in SEQ ID NO. 1 or 2, and thereby the properties of the enzyme are essentially the same as those of the α-amylase according to SEQ ID NO. 1 or 2. This is particularly valid for a substitution with another amino acid of the same family; in this connexion, the families of the aliphatic (G, A, V, L, I), the sulfur-containing (C, M), the aromatic (F, Y, W), the neutral (S, T, N, Q), the acid (D, E) and the basic amino acids (H, K, R) and the special case of the imino acid proline are generally differentiated. The same is true for the insertion or deletion of an amino acid or the deletion of a few, particularly terminal amino acids.

Herewith, one has to especially allow for the aspect that numerous α-amylases are described in the prior art, which differ from one another in only a few positions (compare the identities of AA349 and AA560; see above). Thus, it is possible, starting with a wild type sequence, which differs in only a few positions from the sequence described in SEQ ID NO. 3, to carry out the substitutions highlighted in FIG. 1 and thereby to obtain a useful, equally as good enzyme as that according to SEQ ID NO. 1 or SEQ ID NO. 2. According to the invention, it is then no longer needed to further mutate or back-mutate this enzyme corresponding to SEQ ID NO. 3 when the minimal differences lie in less crucial positions for the total activity and the effect according to the invention is already achieved by the corresponding positions of SEQ ID NO. 1 or SEQ ID NO. 2 highlighted in FIG. 1.

In principle, the same is true for embodiments in which an α-amylase according to the invention is fused with a polymer, preferably another enzyme. Thus, according to the application WO 99/48918 A1, for example, polymers are coupled on enzymes in order to reduce their immunogenicity. WO 99/57250 A1 teaches that a cellulose-binding domain can also be coupled by means of suitable linkers on e.g. an amylase so as to increase the effect of this enzyme on the surface of the material being cleaned. α-Amylases relevant to the invention can also be improved in regard to their use in detergents by both types of modifications, and then constitute correspondingly preferred embodiments.

Further preferred are those detergents according to the invention, wherein the non-ionic surfactant (component a) is comprised in concentrations of 0.5 to 40 wt. %, preferably from 2.5 to 25 wt. %, particularly preferably from 5 to 20 wt. %, quite particularly preferably from 5 to 12 wt. %, each based on the total agent.

These amounts have turned out to be advantageous, particularly in the embodiment of the automatic dishwasher agent.

Further preferred are those detergents according to the invention, wherein the α-amylase is comprised in concentrations of 0.00000001 (1·10⁻⁸) weight percent to 0.05 wt. %, preferably from 0.00001 to 0.03 wt. % and particularly preferably from 0.001 to 0.015 wt. %, whereby in each case is expressed the amount of the pure active enzyme per weight of the agent.

These amounts have turned out to be advantageous, particularly in the embodiment of the automatic dishwasher agent. Above all, this is true when the surfactants (component a) relevant to the invention are present in the above-cited concentration ranges. Here it was observed that both components have the ability to complement one another in regard to the cleaning performance of the relevant agent.

Further preferred are such detergents according to the invention, which comprise further enzymes, preferably selected from the group of proteases, further α-amylases, lipases, cutinases, hemicellulases, hereunder particularly β-glucanases, and oxidoreductases, hereunder particularly oxidases, peroxidases and/or laccases, particularly preferably with alkaline proteases.

To increase their cleaning power, agents according to the invention can comprise enzymes, in principle any enzyme established for these purposes in the prior art being useable, their mixtures being preferred. In principle, these enzymes are of natural origin; improved variants based on the natural molecules are available for use in detergents and accordingly they are preferred. The detergents according to the invention preferably comprise enzymes in total quantities of 1×10⁻⁸ to 5 weight percent based on active protein. The protein concentration can be determined using known methods, for example the BCA Process (bicinchoninic acid; 2,2′-bichinolyl-4,4′-dicarboxylic acid) or the biuret process (A. G. Gomall, C. S. Bardawill and M. M. David, J. Biol. Chem., 177 (1948), p. 751-766).

Preferred proteases are those of the subtilisin type. Examples of these are subtilisins BPN' and Carlsberg, the protease PB92, the subtilisins 147 and 309, the alkaline protease from Bacillus lentus, subtilisin DY and those enzymes of the subtilases no longer however classified in the stricter sense as subtilisines thermitase, proteinase K and the proteases TW3 und TW7. Subtilisin Carlsberg in further developed form is available under the trade name Alcalase® from Novozymes A/S, Bagsvaerd, Denmark. Subtilisins 147 and 309 are commercialized under the trade names Esperase® and Savinase® by the Novozymes company. Variants derived from the protease from Bacillus lentus DSM 5483 (WO 91/02792 A1) called BLAP® are described especially in WO 92/21760 A1, WO 95/23221 A1, WO 02/088340 A2 and WO 03/038082 A2. Further useable proteases from various Bacillus sp. and B. gibsonii emerge from the patent applications WO 03/054185 A1, WO 03/056017 A2, WO 03/055974 A2 and WO 03/054184 A1.

Further useable proteases are, for example, those enzymes available with the trade names Durazym®, Relase®, Everlase®, Nafizym, Natalase®, Kannase® and Ovozymes® from the Novozymes Company, those under the trade names Purafect®, Purafect® OxP and Properase® from Genencor, that under the trade name Protosol® from Advanced Biochemicals Ltd., Thane, India, that under the trade name Wuxi® from Wuxi Snyder Bioproducts Ltd., China, those under the trade names Proleather® and Protease P® from Amano Pharmaceuticals Ltd., Nagoya, Japan, and that under the designation Proteinase K-16 from Kao Corp., Tokyo, Japan.

Examples of further useable amylases according to the invention are the α-amylases from Bacillus licheniformis, from B. amyloliquefaciens and from B. stearothermophilus, as well as their improved further developments for use in detergents. The enzyme from B. licheniformis is available from the Novozymes Company under the name Termamyl® and from the Genencor Company under the name Purastar® ST. Further development products of this α-amylase are available from the Novozymes Company under the trade names Duramyl® and Termamyl®ultra, from the Genencor Company under the name Purastar® OxAm and from Daiwa Seiko Inc., Tokyo, Japan as Keistase®. The α-amylase from B. amyloliquefaciens is commercialized by the Novozymes Company under the name BAN®, and derived variants from the α-amylase from B. stearothermophilus under the names BSG® and Novamyl® also from the Novozymes Company.

Moreover, for these purposes, attention should be drawn to the α-amylase from Bacillus sp. A 7-7 (DSM 12368) disclosed in the application WO 02/10356 A2 and the cyclodextrin-glucanotransferase (CGTase) from B. agaradherens (DSM 9948) described in the application WO 02/44350 A2. Furthermore, the amylolytic enzymes are useable, which belong to the sequence space of α-amylase, described in the application WO 03/002711 A2 and those described in the application WO 03/054177 A2. Similarly, fusion products of the cited molecules are applicable, for example those from the application DE 10138753 A1.

Moreover, further developments of α-amylase from Aspergillus niger und A. oryzae available from the Company Novozymes under the trade name Fungamyl® are suitable. Further suitable commercial products are, for example Amylase-LT®.

The agents according to the invention can comprise lipases or cutinases, particularly due to their triglyceride cleaving activities, but also in order to produce in situ peracids from suitable preliminary steps. These include the available or further developed lipases originating from Humicola lanuginosa (Thermomyces lanuginosus), particularly those with the amino acid substitution D96L. They are commercialized, for example by the Novozymes Company under the trade names Lipolase®, Lipolase®Ultra, LipoPrime®, Lipozyme® and Lipex®. Moreover, suitable cutinases, for example are those that were originally isolated from Fusarium solanipisi and Humicola insolens. Likewise useable lipases are available from the Amano Company under the designations Lipase CE®, Lipase P®, Lipase B®, and Lipase CES®, Lipase AKG®, Bacillis sp. Lipase®, Lipase AP®, Lipase M-AP® and Lipase AML®. Suitable lipases or cutinases whose starting enzymes were originally isolated from Pseudomonas mendocina und Fusarium solanii are for example available from Genencor Company. Further important commercial products that may be mentioned are the commercial preparations M1 Lipase® und Lipomax® originally from Gist-Brocades Company, and the commercial enzymes from the Meito Sangyo KK Company, Japan under the names Lipase MY-30®, Lipase OF® and Lipase PL® as well as the product Lumafast® from Genencor Company.

The agents according to the invention can comprise additional enzymes especially for removing specific problem stains and which are summarized under the term hemicellulases. These include, for example mannanases, xanthanlyases, pectinlyases (=pectinases), pectinesterases, pectatlyases, xyloglucanases (=xylanases), pullulanases und β-glucanases. Suitable mannanases, for example are available under the names Gamanase® and Pektinex AR® from Novozymes Company, under the names Rohapec® B1L from AB Enzymes, under the names Pyrolase® from Diversa Corp., San Diego, Calif., USA, and under the names Purabrite® from Genencor Int., Inc., Palo Alto, Calif., USA. A suitable β-glucanase from a B. alcalophilus is described, for example in the application WO 99/06573 A1. β-Glucanase extracted from B. subtilis is available under the name Cereflo® from Novozymes Company.

To increase the bleaching action, the detergents according to the invention can comprise oxidoreductases, for example oxidases, oxygenases, katalases, peroxidases, like halo-, chloro-, bromo-, lignin-, glucose- or manganese-peroxidases, dioxygenases or laccases (phenoloxidases, polyphenoloxidases). Suitable commercial products are Denilite® 1 and 2 from the Novozymes Company. Advantageously, additional, preferably organic, particularly preferably aromatic compounds are added that interact with the enzymes to enhance the activity of the relative oxidoreductases or to facilitate the electron flow (mediators) between the oxidizing enzymes and the stains over strongly different redox potentials.

The enzymes used in the agents according to the invention either stem originally from microorganisms, such as the species Bacillus, Streptomyces, Humicola, or Pseudomonas, and/or are produced according to known biotechnological processes using suitable microorganisms such as by transgenic expression hosts of the species Bacillus or filamentary fungi.

Purification of the relevant enzymes follows conveniently using established processes such as precipitation, sedimentation, concentration, filtration of the liquid phases, microfiltration, ultrafiltration, mixing with chemicals, deodorization or suitable combinations of these steps.

The enzymes can be added to the inventive agents in each established form according to the prior art. Included here, for example, are solid preparations obtained by granulation, extrusion or lyophilization, or particularly for liquid agents or agents in the form of gels, enzyme solutions, advantageously highly concentrated, of low moisture content and/or mixed with stabilizers (see above).

Alternatively, all enzymes, both for solid as well as for liquid presentation forms, can be encapsulated, as is already described above for the enzymes essential to the invention.

In addition, it is possible to formulate two or more enzymes together, so that a single granulate exhibits a plurality of enzymatic activities.

In accordance with the above statements, enzyme-containing detergents are preferred, wherein the alkaline protease is a variant of an alkaline protease of the subtilisin type, whose starting molecule is naturally formed from a Bacillus species, preferably from B. gibsoniii (DSM 14391), B. sp. (DSM 14390), B. sp. (DSM 14392), B. gibsonii (DSM 14393) or B. lentus, particularly preferably from B. lentus DSM 5483).

They are available to the expert from the literature cited above and due in no small part to the cited examples therein, have proven particularly useful for use in automatic dishwasher agents.

In the following, application possibilities according to the invention are specified, which are accordingly characterized and preferred with agents according to the invention based on the previous embodiments.

This concerns the general use of an α-amylase according to SEQ ID NO. 1 or SEQ ID NO. 2 (as component b) to increase the cleaning performance of a detergent comprising a non-ionic surfactant as defined above as component a.

All the embodiments formulated above are correspondingly valid for this.

Further such embodiments are:
appropriate uses, referring to an automatic dishwasher agent.
appropriate uses, wherein the non-ionic surfactant (component a) and the α-amylase (component b) are present in the same phase.
appropriate uses, wherein, in regard to this use, the α-amylase, in comparison with the α-amylase according to SEQ ID NO. 1 or SEQ ID NO. 2, is a modified α-amylase that can be derived by means of one of the following mutations or derivatizations of the α-amylase described by SEQ ID NO. 1 or SEQ ID NO. 2:
(a) substitution of an amino acid
(b) insertion of an amino acid,
(c) deletion of an amino acid,
(d) deletion of 2, 3, 4 or 5 amino acids at the C-terminus or at the N-terminus or
(e) fusion with another polymer, preferably another enzyme.
appropriate uses, wherein the non-ionic surfactant (component a) is employed in concentrations from 0.01 to 2, preferably from 0.05 to 1, particularly preferably from 0.1 to 0.8, and quite particularly preferably 0.2 to 0.48 g per 1 cleaning liquor.
appropriate uses, wherein the α-amylase is employed in concentrations from 0.05 to 15, preferably from 0,1 to 10 and particularly preferably from 0,4 to 5 KNU per 1 cleaning liquor.
appropriate uses, wherein further enzymes are simultaneously used with the α-amylase, preferably selected from the group of proteases, further α-amylases, lipases, cutinases, hemicellulases, hereunder particularly β-glucanases, and oxidoreductases, hereunder particularly oxidases, peroxidases and/or laccases, particularly preferably with alkaline proteases.
appropriate uses, wherein the alkaline protease is a variant of an alkaline protease of the subtilisin type, whose starting molecule is naturally formed from a Bacillus species, preferably from B. gibsonii (DSM 14391), B. sp. (DSM 14390), B. sp. (DSM 14392), B. gibsonii (DSM 14393) or B. lentus, particularly preferably from B. lentus DSM 5483).

A further subject of the invention is constituted by processes in which the present invention is realized. That is, in general, processes for cleaning solid surfaces with the use of one of the inventive detergents described above.

In a preferred embodiment, the process is to clean dishes, preferably in an automatic dishwasher process. Especially with regard to this embodiment, both the components that characterize the present invention were selected.

A further preferred embodiment concerns a process wherein the non-ionic surfactant (component a) in concentrations of 0.01 to 2g per 1 cleaning liquor and simultaneously the α-amylase in concentrations of 0,05 to 15 KNU per 1 cleaning liquor are used, preferably the non-ionic surfactant (component a) in concentrations of 0,05 to 1 g per 1 cleaning liquor and simultaneously the α-amylase in concentrations of 0,1 to 10 KNU per 1 cleaning liquor, and particularly preferably the non-ionic surfactant (component a) in concentrations of 0,1 to 0,8 g per 1 cleaning liquor and simultaneously the α-amylase in concentrations of 0,4 to 5 KNU per 1 cleaning liquor.

Especially these concentration values, quite particularly in these combinations have emerged from experiments as being advantageous.

Pursuant to the previous statements, the present invention is also realized by the use of the inventive detergents cited above for cleaning hard surfaces.

This particularly concerns the use to clean dishes, preferably by automatic dishwashing.

Here, as discussed, it is advantageous and accordingly preferred when the non-ionic surfactant (component a) in concentrations of 0.01 to 2g per 1 cleaning liquor and simultaneously the α-amylase in concentrations of 0,05 to 15 KNU per 1 cleaning liquor are used, preferably the non-ionic surfactant (component a) in concentrations of 0,05 to 1 g per 1 cleaning liquor and simultaneously the α-amylase in concentrations of 0,1 to 10 KNU per 1 cleaning liquor, and particularly preferably the non-ionic surfactant (component a) in concentrations of 0,1 to 0,8 g per 1 cleaning liquor and simultaneously the α-amylase in concentrations of 0,4 to 5 KNU per 1 cleaning liquor.

### DESCRIPTION OF THE FIGURES

FIG. 1: Alignment of the amino acid sequences of the α-amylase according to SEQ ID NO. 1 (SEQ.1), SEQ ID NO. 2 (SEQ.2) and the α-amylase AA349 (AA349) (SEQ ID NO:3).

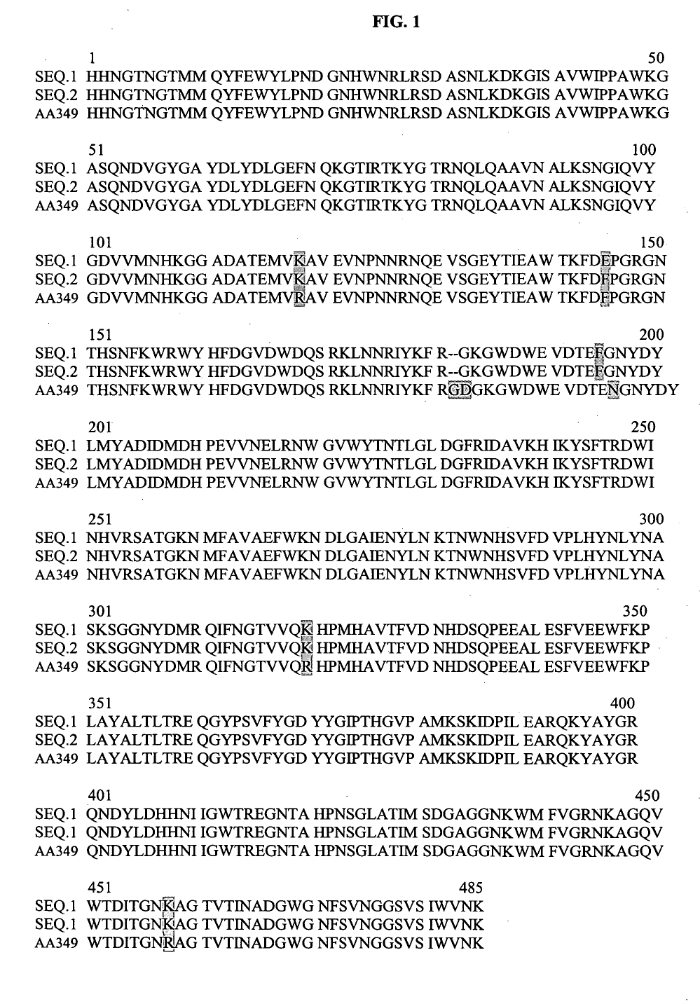

The differences with the α-amylase AA349 (SEQ ID NO:3) in the positions 118, 182, 183, 195, 320 and 458—and for SEQ ID NO. 1 additionally in position 145—counted with respect to the α-amylase AA349 (SEQ ID NO:3), are highlighted by gray markings.

1. A detergent comprising
at least one non-ionic surfactant having the formula: 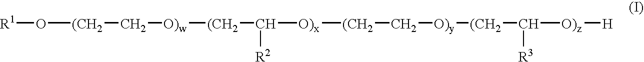
wherein
R¹ is a straight or branched, saturated or mono- or polyunsaturated alkyl or alkenyl group of 6 to 24 carbon atoms;
R² and R³ are, independently, —CH₃, —CH₂CH₃, —CH₂CH₂CH₃ or —CH(CH₃)₂; and
w, x, y, and z are, independently, an integer from 1 to 6;
or at least one non-ionic surfactant having the formula:
R¹—CH(OH)CH₂O-(AO)_{w}-(A′O)ₓ-(A″O)_{y}-(A′″O)_{z}—R² (II)
wherein
R¹ is a straight or branched, saturated or mono- or polyunsaturated alkyl or alkenyl group of 6 to 24 carbon atoms;
R² is a linear or branched hydrocarbon group of 2 to 26 carbon atoms;
A, A′, A″ and A′″ are, independently, —CH₂CH₂—, —CH₂CH₂CH₂—, —CH₂CH(CH₃)—, —CH₂CH₂CH₂CH₂—, —CH₂CH(CH₃)CH₂— or —CH₂CH(CH₂CH₃)—; and
w, x, y and z are, independently, 0 or an integer from 1 to 25;
together with at least one non-ionic surfactant having the formula:
R¹—O-(AO)_{w}-(A′O)ₓ-(A″O)_{y}-(A′″O)_{z}—R² (III)
wherein
R¹ is a straight or branched, saturated or mono- or polyunsaturated alkyl or alkenyl group of 6 to 24 carbon atoms,
R² is H or a linear or branched hydrocarbon group of 2 to 26 carbon atoms,
A, A′, A″ and A′″ are, independently, —CH₂CH₂—, —CH₂CH₂CH₂—, —CH₂CH(CH₃)—, —CH₂CH₂CH₂CH₂—, —CH₂CH(CH₃)CH₂— or —CH₂CH(CH₂CH₃)—; and
w, x, y and z are, independently, 0 or an integer from 1 to 25;
wherein the weight ratio of the non-ionic surfactant F to the non-ionic surfactant G is from 1:4 to 100:1;
and an α-amylase according to SEQ ID NO:1 or SEQ ID NO:2.

2. The detergent according to claim 1 wherein the detergent exists in the form of a multi-phase tablet and the non-ionic surfactant and the α-amylase are present in the same phase.

3. The detergent according to claim 1 wherein R¹ of Formula I is an alkyl group of 8 to 20 carbon atoms.

4. The detergent according claim 1 wherein R² and R³ of Formula I are —CH₃; w and x are, independently, 3 or 4; and y and z are, independently, 1 or 2.

5. The detergent according to claim 1 wherein the weight ratio of the non-ionic surfactant F to the non-ionic surfactant G is from 2:9 to 90:1.

6. The detergent according claim 1 wherein the weight percentage of the non-ionic surfactant is from 0.5% to 40%.

7. The detergent according claim 6 wherein the weight percentage of the non-ionic surfactant is from 5% to 12%.

8. The detergent according to claim 1 wherein the weight percentage of the α-amylase is from 0.00000001% to 0.05%.

9. The detergent according to claim 8 wherein the weight percentage of the α-amylase is from 0.001% to 0.015%.

10. The detergent according to claim 1 comprising at least one additional enzyme selected from the group consisting of a protease, an α-amylase, a lipase, a cutinase, a hemicellulase, a β-glucanase, an oxidoreductase, an oxidase, a peroxidase, a laccase, and an alkaline protease.

11. The detergent according to claim 10 wherein the alkaline protease is a variant of an alkaline protease of the subtilisin type, whose starting molecule is naturally formed from a Bacillus species selected from the group consisting of B. gibsonii, B. sp., B. gibsonii, and B. lentus.

12. A detergent comprising
a non-ionic surfactant having the formula:
R¹O[CH₂CH(CH₃)O]ₓ[CH₂CH₂O]_{y}CH₂CH(OH)R²
wherein
R¹ is a linear or branched aliphatic hydrocarbon group of 4 to 18 carbon atoms;
R² is a linear or branched hydrocarbon group of 2 to 26 carbon atoms;
x is the integer 1 or 2; and
y is an integer from 0 to 15; and
an α-amylase according to SEQ ID NO:1 or SEQ ID NO:2.

13. A detergent comprising
a non-ionic surfactant having the formula:
R¹O[CH₂CH(R³)O]ₓR²
wherein
R¹ is a linear or branched, saturated or unsaturated, aliphatic or aromatic hydrocarbon group of 1 to 30 carbon atoms;
R² is a linear or branched, saturated or unsaturated, aliphatic or aromatic hydrocarbon group of 1 to 30 carbon atoms having 1 to 5 hydroxyl group substituents optionally functionalized with ether groups;
R³ is H or a methyl, ethyl, n-propyl, iso-propyl, n-butyl, 2-butyl or 2-methyl-2-butyl group; and
x an integer from I to 40; and
an α-amylase according to SEQ ID NO:1 or SEQ ID NO:2.

14. A detergent comprising
a non-ionic surfactant having the formula:
R¹O[CH₂CH₂O]ₓCH₂CH(OH)R²
wherein
R¹ is a linear or branched, saturated or unsaturated, aliphatic or aromatic hydrocarbon group having 1 to 30 carbon atoms;
R² is a linear or branched, saturated or unsaturated, aliphatic or aromatic hydrocarbon group having 1 to 30 carbon atoms; and
x is an integer from 1 to 90; and
an α-amylase according to SEQ ID NO:1 or SEQ ID NO:2.

15. A detergent comprising
a non-ionic surfactant having the formula: 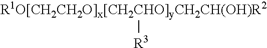
wherein
R¹ and R² are, independently, a linear or branched, saturated or mono- or polyunsaturated hydrocarbon group of 2 to 26 carbon atoms;
R³ is —CH₃, —CH₂CH₃, —CH₂CH₂CH₃ or —CH(CH₃)₂; and
x and y are, independently, an integer from 1 to 32; and
an aα-amylase according to SEQ ID NO:1 or SEQ ID NO:2.

16. A detergent comprising
a non-ionic surfactant having the formula: 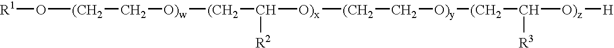
wherein
R¹ is a straight or branched, saturated or mono- or polyunsaturated alkyl or alkenyl group of 6 to 24 carbon atoms;
R² and R³ are, independently, —H, —CH₃, —CH₂CH₃, —CH₂CH₂CH₃ or CH(CH₃)₂; and
w, x, y, and z are, independently, an integer from 1 to 6; and
an α-amylase according to SEQ ID NO:1 or SEQ ID NO:2.

17. A method for increasing the cleaning performance of a detergent comprising adding an α-amylase according to SEQ ID NO:1 or SEQ ID NO:2 to the detergent, wherein the detergent comprises
at least one non-ionic surfactant having the formula: 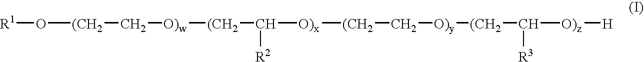
wherein
R¹ is a straight or branched, saturated or mono- or polyunsaturated alkyl or alkenyl group of 6 to 24 carbon atoms;
R² and R³ are, independently, —CH₃, —CH₂CH₃, —CH₂CH₂CH₃ or —CH(CH₃)₂; and
w, x, y, and z are, independently, an integer from 1 to 6;
or at least one non-ionic surfactant having the formula:
R¹—CH(OH)CH₂O-(AO)_{w}-(A′O)ₓ-(A″O)_{y}-(A′″O)_{z}—R² (II)
wherein
R¹ is a straight or branched, saturated or mono- or polyunsaturated alkyl or alkenyl group of 6 to 24 carbon atoms;
R² is a linear or branched hydrocarbon group of 2 to 26 carbon atoms;
A, A′, A″ and A′″ are, independently, —CH₂CH₂—, —CH₂CH₂CH₂—, —CH₂CH(CH₃)—, —CH₂CH₂CH₂CH₂—, —CH₂CH(CH₃)CH₂— or —CH₂CH(CH₂CH₃)—; and
w, x, y and z are, independently, 0 or an integer from 1 to 25;
together with at least one non-ionic surfactant having the formula:
R¹—O-(AO)_{w}-(A′O)ₓ-(A″O)_{y}-(A′″O)_{z}—R² (III)
wherein
R¹ is a straight or branched, saturated or mono- or polyunsaturated alkyl or alkenyl group of 6 to 24 carbon atoms,
R² is H or a linear or branched hydrocarbon group of 2 to 26 carbon atoms,
A, A′, A″ and A′″ are, independently, —CH₂CH₂—, —CH₂CH₂CH₂—, —CH₂CH(CH₃)—, —CH₂CH₂CH₂CH₂—, —CH₂CH(CH₃)CH₂— or —CH₂CH(CH₂CH₃)—; and
w, x, y and z are, independently, 0 or an integer from 1 to 25;
wherein the weight ratio of the non-ionic surfactant F to the non-ionic surfactant G is from 1:4 to 100:1,

18. The method according to claim 17 wherein the detergent exists in the form of a multi-phase tablet and the non-ionic surfactant and the α-amylase are present in the same phase.

19. The method according to claim 17 wherein the concentration of the non-ionic surfactant is from 0.01 to 2 g per 1 cleaning liquor.

20. The method according to claim 17 wherein the concentration of the α-amylase is from 0.05 to 15 KNU per 1 cleaning liquor.

21. The method according to claim 17 further comprising adding an additional enzyme selected from the group consisting of a protease, an α-amylase, a lipase, a cutinase, a hemicellulase, a β-glucanase, an oxidoreductase, an oxidase, a peroxidase, a laccase, and an alkaline protease to the detergent.

22. The method according to claim 21 wherein the alkaline protease is a variant of an alkaline protease of the subtilisin type, whose starting molecule is naturally formed from a Bacillus species selected from the group consisting of B. gibsonii, B. sp., B. gibsonii, and B. lentus.

23. A method for cleaning hard surfaces comprising contacting the surfaces with a detergent comprising
at least one non-ionic surfactant having the formula: 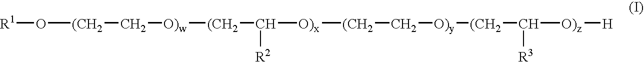
wherein
R¹ is a straight or branched, saturated or mono- or polyunsaturated alkyl or alkenyl group of 6 to 24 carbon atoms;
R² and R³ are, independently, —CH₃, —CH₂CH₃, —CH₂CH₂CH₃ or —CH(CH₃)₂; and
w, x, y, and z are, independently, an integer from 1 to 6;
or at least one non-ionic surfactant having the formula:
R¹—CH(OH)CH₂O-(AO)_{w}-(A′O)ₓ-(A″O)_{y}-(A′″O)_{z}—R² (II)
wherein
R¹ is a straight or branched, saturated or mono- or polyunsaturated alkyl or alkenyl group of 6 to 24 carbon atoms;
R² is a linear or branched hydrocarbon group of 2 to 26 carbon atoms;
A, A′, A″ and A′″ are, independently, —CH₂CH₂—, —CH₂CH₂CH₂—, —CH₂CH(CH₃)—, —CH₂CH₂CH₂CH₂—, —CH₂CH(CH₃)CH₂— or —CH₂CH(CH₂CH₃)—; and
w, x, y and z are, independently, 0 or an integer from 1 to 25;
together with at least one non-ionic surfactant having the formula:
R¹—O-(AO)_{w}-(A′O)ₓ-(A″O)_{y}-(A′″O)_{z}—R² (III)
wherein
R¹ is a straight or branched, saturated or mono- or polyunsaturated alkyl or alkenyl group of 6 to 24 carbon atoms,
R² is H or a linear or branched hydrocarbon group of 2 to 26 carbon atoms,
A, A′, A″ and A′″ are, independently, —CH₂CH₂—, —CH₂CH₂CH₂—, —CH₂CH(CH₃)—, —CH₂CH₂CH₂CH₂—, —CH₂CH(CH₃)CH₂— or —CH₂CH(CH₂CH₃)—; and
w, x, y and z are, independently, 0 or an integer from 1 to 25;
wherein the weight ratio of the non-ionic surfactant F to the non-ionic surfactant G is from 1:4 to 100:1,
and an α-amylase according to SEQ ID NO:1 or SEQ ID NO:2.

24. The method according to claim 23 wherein the concentration of the non-ionic surfactant is from 0.01 to 2 g per 1 cleaning liquor and the concentration of the α-amylase is from 0.05 to 15 KNU per 1 cleaning liquor.


SEQUENCE LISTING (3 sequences)

SEQ ID NO: 1 - protein, 483 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVKAVEVNPNNRNQEVSGEYTIEAWTKFDEPGRGNTHSNFKWRWYHFDGVDWDQSRKLNNRIYKFRGKGWDWEVDTEFGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQKHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNKAGTVTINADGWGNFSVNGGSVSIWVNK

SEQ ID NO: 2 - protein, 483 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVKAVEVNPNNRNQEVSGEYTIEAWTKFDFPGRGNTHSNFKWRWYHFDGVDWDQSRKLNNRIYKFRGKGWDWEVDTEFGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQKHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNKAGTVTINADGWGNFSVNGGSVSIWVNK

SEQ ID NO: 3 - protein, 485 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK